(19) United States
(12) Patent Application Publication
(10) Pub. No.: US 2025/0161806 A1
(43) Pub. Date: May 22, 2025

(54) RECORDING MEDIUM AND INFORMATION PROCESSING APPARATUS

(71) Applicants: SEGA CORPORATION, Tokyo (JP); COLORFUL PALETTE INC., Tokyo (JP)

(72) Inventors: Yuichiro KONDO, Tokyo (JP); Tomoya YAMAGUCHI, Tokyo (JP); Shingo KOSUGE, Tokyo (JP)

(73) Assignees: SEGA CORPORATION, Tokyo (JP); COLORFUL PALETTE INC., Tokyo (JP)

(21) Appl. No.: 18/722,585

(22) PCT Filed: Dec. 20, 2022
(86) PCT No.: PCT/JP2022/046913

§ 371 Date: Jun. 21, 2024

(30) Foreign Application Priority Data
Dec. 21, 2021 (JP) 2021-207490

(51) Int. Cl. A63F 13/52

(52) U.S. Cl. CPC A63F 13/52

(57) ABSTRACT

A recording medium and an information processing apparatus. The recording medium according to the records a program causing a computer communicable with a terminal apparatus of a player who participates in a live venue in which a predetermined musical performance or a predetermined performance is executed to function as: an execution resource causes a performer character corresponding to a performer who performs the musical performance or the performance to execute an action according to a motion or voice of the performer, cause a player character corresponding to the player to execute an action according to an operation on the player's terminal apparatus, and cause a non-player character who is different from the player character to execute an action automatically by the computer; and a change resource changing the action of the non-player character according to the action of the performer character or the action of the player character.

### CROSS REFERENCE TO RELATED APPLICATIONS

This application claims priority to Japanese Patent Application No. 2021-207490, filed on Dec. 21, 2021, the contents of which are incorporated here by reference in their entirety.

### TECHNICAL FIELD

The present invention relates to a recording medium and an information processing apparatus.

### BACKGROUND

Conventionally known is a game that displays images in which a virtual character representing a player participates as an audience in a musical performance venue or a performance venue.

Regarding the game, for example, the following Patent Literature 1 discloses a game that displays, as images in which a first virtual character representing a player who participates in a virtual live venue as an audience, the first virtual character and second virtual characters representing a surrounding audience. The game causes the first virtual character to perform a predetermined action such as an action of clapping and an action of waving a penlight based on the player's operation.

### PATENT LITERATURE

Patent Literature 1: JP2011-206267A

### SUMMARY

In the technique disclosed in the above-mentioned Patent Literature 1, since a predetermined video is displayed as a performer's live video, the second virtual characters representing the surrounding audience also perform a fixed motion so as to be matched with the live video. For this reason, there is a possibility that the virtual live venue reproduced by the technique deviates from a real live venue, and it is difficult to give a player a sense of immersion, which is a sense as if the player were participating in a live in the real live venue.

The present invention has been made in consideration of such issues, and is directed to provision of a recording medium and an information processing apparatus that are capable of giving a player a sense of immersion, which is a sense as if the player were participating in a live in a real live venue.

A recording medium according to a first aspect of the present invention is a computer-readable recording medium that records a program for causing a computer that is communicable with a terminal apparatus of a player who participates in a venue in which a predetermined musical performance or a predetermined performance is executed to function as: an execution means configured to cause a virtual performer character corresponding to a performer who performs the predetermined musical performance or the predetermined performance to execute an action according to a motion or voice of the performer, cause a first virtual character corresponding to the player to execute an action according to an operation on the player's terminal apparatus, and cause a second virtual character who is different from the first virtual character to execute an action under automatic control by the computer; a display control means configured to perform, on the player's terminal apparatus, display control of the venue and also display control of the virtual performer character, the first virtual character, the second virtual character, and an action of each character to be executed by the execution means; and a change means configured to change the action of the second virtual character according to the action of the virtual performer character or the action of the first virtual character.

In the recording medium according to a second aspect of the present invention, the program causes the computer to further function as a display control means configured to perform, on the player's terminal apparatus, display control of the venue and also display control of the virtual performer character, the first virtual character, the second virtual character, and an action of each character to be executed by the execution means. The execution means is configured to cause the first virtual character to execute an action of presenting, to the venue, a virtual object associated with the first virtual character in a display pattern selected according to an operation on the player's terminal apparatus, and cause the second virtual character to execute an action of presenting, to the venue, a virtual object associated with the second virtual character by automatic control by the computer. The change means is configured to change a display pattern of the virtual object associated with the second virtual character according to the display pattern regarding the first virtual character, the display pattern being selected according to the operation.

In the recording medium according to a third aspect of the present invention, the display control means is configured to perform display control of a plurality of the first virtual characters corresponding to a plurality of the players. The execution means is configured to cause the plurality of first virtual characters to execute an action of presenting, to the venue, corresponding virtual objects associated with the plurality of first virtual characters in corresponding display patterns selected according to operations on respective players' terminal apparatuses. The change means is configured to change the display pattern of the virtual object associated with the second virtual character according to a total number or ratio of the display patterns selected regarding the plurality of first virtual characters according to the operations.

In the recording medium according to a fourth aspect of the present invention, the display control means is configured to hide the second virtual character in a case where the second virtual character is located within a predetermined range with respect to the first virtual character.

In the recording medium according to a fifth aspect of the present invention, the display control means is configured to perform display control of the virtual performer character in a stage area of the venue and also display control of the first and second virtual characters in an audience seat area of the venue. In a case where the second virtual character is located in an area between the first virtual character corresponding to one player and the stage area and along a direction from the first virtual character toward the stage area, the predetermined range to be set is larger than a predetermined range to be set in a case where the second virtual character is located in an area other than the area in the audience seat area.

In the recording medium according to a sixth aspect of the present invention, when the predetermined range is a first predetermined range, the display control means is configured to perform display control of a plurality of the first virtual characters corresponding to a plurality of the players including one player and another player other than the one player. In a case where a first virtual character corresponding to the other player out of the plurality of first virtual characters is located, with respect to a first virtual character corresponding to the one player out of the plurality of first virtual characters, in a second predetermined range that is smaller than the first predetermined range, the display control means is configured to hide the first virtual character corresponding to the other player.

In the recording medium according to a seventh aspect of the present invention, the execution means is configured to, before start of the musical performance or the performance, cause the second virtual character to execute an action of moving within a predetermined movement range in an audience seat area of the venue, and also configured to, after the start of the musical performance or the performance, cause the second virtual character to execute an action of stopping the movement and changing in orientation to a stage area side of the venue.

In the recording medium according to an eighth aspect of the present invention, the display control means is configured to perform display control of a plurality of the second virtual characters so that a density of characters including the first virtual character and the second virtual characters in each of the areas is a predetermined value or more in a case where an audience seat area of the venue is divided into a plurality of areas.

In the recording medium according to a ninth aspect of the present invention, when the action of the virtual performer character or the action of the first virtual character changes, the change means is configured to change the action of the second virtual character according to the changed action.

An information processing apparatus according to a tenth aspect of the present invention is communicable with a terminal apparatus of a player who participates in a venue in which a predetermined musical performance or a predetermined performance is executed. The information processing apparatus includes: an execution means configured to cause a virtual performer character corresponding to a performer who performs the predetermined musical performance or the predetermined performance to execute an action according to a motion or voice of the performer, cause a first virtual character corresponding to the player to execute an action according to an operation on the player's terminal apparatus, and cause a second virtual character who is different from the first virtual character to execute an action under automatic control by a computer; and a change means configured to change the action of the second virtual character according to the action of the virtual performer character or the action of the first virtual character.

According to the present invention, it is possible to give a player a sense of immersion, which is a sense as if the player were participating a live in a real live venue.

### BRIEF DESCRIPTION OF DRAWINGS

FIG. 1 is a block diagram illustrating an example of an overall configuration of a game system according to the present embodiment.

FIG. 2 is a block diagram illustrating an example of a hardware configuration of a server apparatus illustrated in FIG. 1.

FIG. 3 is a block diagram schematically illustrating an example of functional components of a server apparatus.

FIG. 4 is a view illustrating an example of an outline of the whole of a live venue.

FIG. 5 is a flowchart describing an example of the flow of game processing in a game system according to the present embodiment.

FIG. 6 is a flowchart describing an example of the flow of virtual live processing described in step SP34 in FIG. 5.

FIG. 7 is a flowchart describing an example of the flow of hiding control processing described in step SP74 in FIG. 6.

FIG. 8 is a flowchart describing an example of the flow of emergency stop processing described in step SP84 in FIG. 6.

FIG. 9 is a flowchart describing an example of the flow of penlight talk processing described in step SP98 in FIG. 6.

FIG. 10 is a view illustrating an example of a virtual live screen that can be viewed from a visual field of a player who operates a self-player character illustrated in FIG. 4.

FIG. 11 is a view illustrating an example of a virtual live screen that can be viewed in a case where the visual field of the player who operates the self-player character illustrated in FIG. 4 is turned to the left side.

FIG. 12 is a view illustrating an example of a virtual live screen during the execution of an MC that can be viewed in a case of zooming in on a stage area side in the visual field illustrated in FIG. 4.

FIG. 13 is a view illustrating an example of a virtual live screen at the time of an emergency stop.

FIG. 14 is a view illustrating an example of a virtual live screen that has been switched from a screen displaying the execution of the MC illustrated in FIG. 12 and that displays the execution of a musical performance.

FIG. 15 is a view illustrating an example of a comment management screen displayed on an administrator's terminal apparatus.

FIG. 16 is a view illustrating an example of a management screen that is displayed on the administrator's terminal at the time of an emergency stop.

FIG. 17 is a flowchart describing the flow of processing performed by a change means according to a modification.

### DETAILED DESCRIPTION

An embodiment of the present invention (hereinafter referred to as “the present embodiment” as appropriate) will be described below with reference to the accompanying drawings. In each drawing, an identical component and an identical step are denoted by an identical reference number as much as possible for facilitating understanding, and an overlapping description is omitted.

### <Overall Configuration>

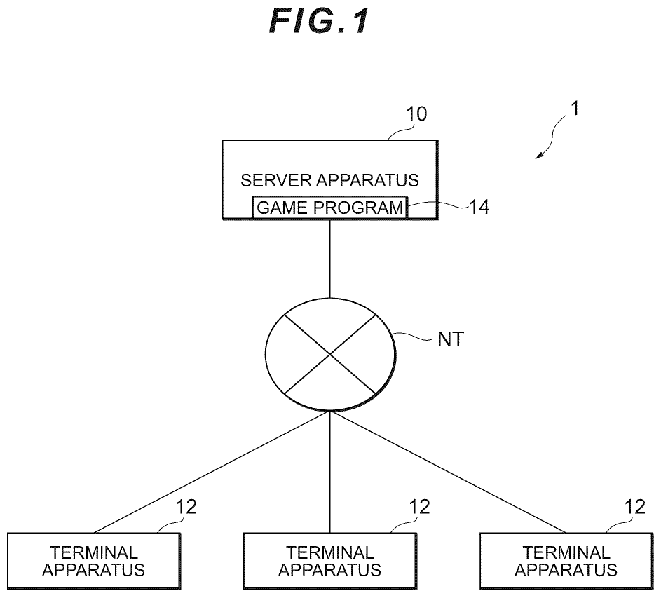

FIG. 1 is a block diagram illustrating an example of an overall configuration of a game system 1 according to the present embodiment.

As illustrated in FIG. 1, the game system 1 includes a server apparatus 10 and a plurality of terminal apparatuses 12. The server apparatus 10 and the terminal apparatuses 12 are communicably connected to each other via a communication network NT such as the Internet, an intranet, and a telephone line.

The server apparatus 10 is an information processing apparatus that provides a user of each terminal apparatus 12, via the communication network NT, with a game execution result obtained by execution of a game program 14 or the game program 14 itself. In the present embodiment, the server apparatus 10 provides the user of the terminal apparatus 12 with the game program 14 itself.

The plurality of terminal apparatuses 12 includes a terminal apparatus 12 of an administrator who manages a predetermined musical performance or a predetermined performance and a terminal apparatus 12 of a player who participates in a venue in which the musical performance or the performance is to be executed. Each terminal apparatus 12 is an information processing apparatus operated by the administrator or the player. For example, after the installation of the game program 14 received from the server apparatus 10, each terminal apparatus 12 executes the game program 14 to provide an operation management application for execution of the predetermined musical performance or the predetermined performance, a game in which the musical performance or the performance is to be executed, or the like. Examples of these terminal apparatuses 12 include various kinds of devices such as a video game console, an arcade game machine, a mobile phone, a smartphone, a tablet, and a personal computer. In the present embodiment, a description will be given of a case where the player's terminal apparatus 12 is a smartphone including a gyro sensor (angular velocity sensor) capable of measuring an angular velocity.

### <Hardware Configuration>

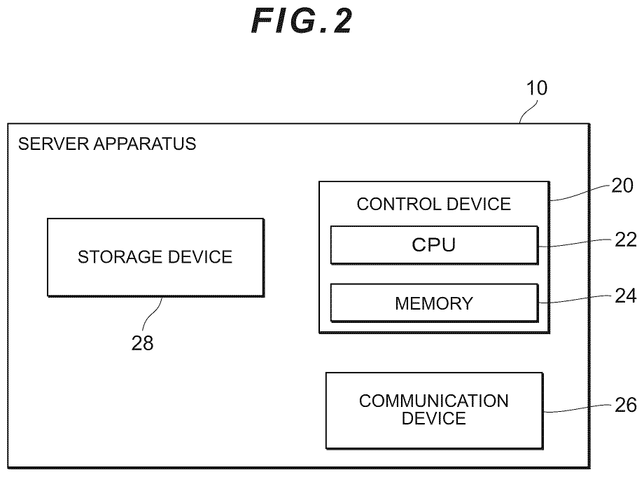

FIG. 2 is a block diagram illustrating an example of a hardware configuration of the server apparatus 10 illustrated in FIG. 1.

As illustrated in FIG. 2, the server apparatus 10 includes a control device 20, a communication device 26, and a storage device 28. The control device 20 is configured to mainly include a central processing unit (CPU) 22 and a memory 24.

The control device 20 functions as various kinds of functional components by the CPU 22 executing a predetermined program stored in the memory 24, a storage device 28, or the like. Details of the functional components will be described later.

The communication device 26 is configured to include a communication interface or the like for performing communication with an external apparatus. This communication device 26, for example, transmits/receives various kinds of information to/from each terminal apparatus 12.

The storage device 28 is an example of a recording medium, and is configured to include a hard disk and the like. The storage device 28 includes various kinds of programs and various kinds of information that are required to execute processing in the control device 20, and information regarding processing results. The various kinds of programs include the game program 14.

Note that the server apparatus 10 can be implemented by use of an information processing apparatus such as a dedicated or general-purpose server computer. Additionally, the server apparatus 10 may be configured to include a single information processing apparatus, or may be configured to include a plurality of information processing apparatuses distributed on the communication network NT. Additionally, FIG. 2 merely illustrates part of a main hardware configuration of the server apparatus 10, and may have another configuration of a typical server. Furthermore, a configuration of each terminal apparatus 12 is similar to that of the server apparatus 10 except for inclusion of an operation means and a display means. Note that as the display means, a head mounted display or the like including a position detection means such as a gyro sensor (angular velocity sensor) and an orientation detection means may be used.

### <Outline of Game>

The game according to the present embodiment is, for example, a music game, a role-playing game, a shooting game, an action game, or the like, and is not particularly limited. The following description will be given of a case where the game is, for example, among music games, a rhythm game in which a player enjoys an operation according to a musical performance or a performance. In such a game, in the present embodiment, the musical performance or the performance is substantially simultaneously executed at a predetermined timing during the game. In a venue of the musical performance or the performance (a musical performance venue or a performance venue), a plurality of first virtual characters corresponding to a plurality of players and capable of performing actions in response to operations of the plurality of players are displayed, whereby the plurality of players is capable of participating an identical venue at the approximately same time. The following description will be given of only the musical performance, but the present embodiment can be applied to the performance.

### <Functional Components>

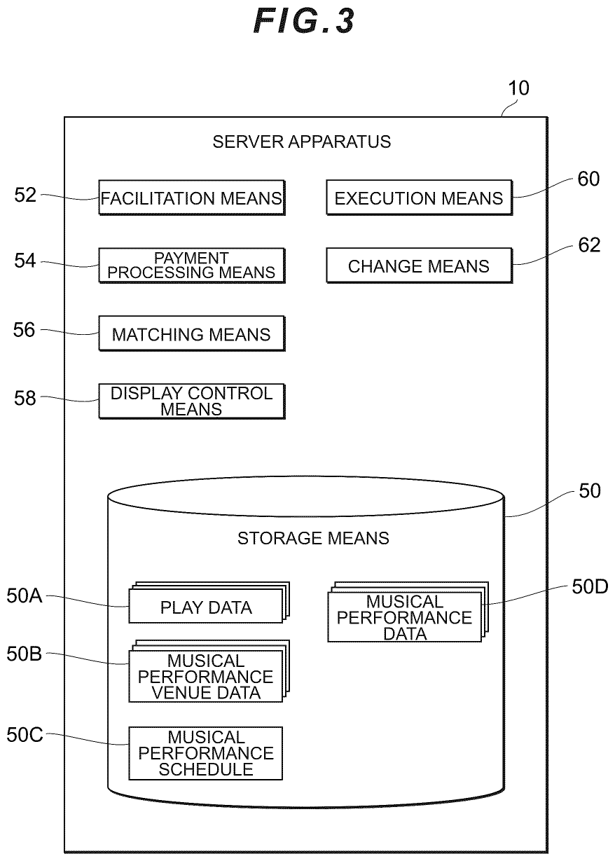

FIG. 3 is a block diagram schematically illustrating an example of functional components of the server apparatus 10.

As illustrated in FIG. 3, the server apparatus 10 includes, as the functional components, a storage means 50, a facilitation means 52, a payment processing means 54, a matching means 56, a display control means 58, an execution means 60, and a change means 62. Note that the storage means 50 is implemented by the storage device 28. The other functional components are implemented by the control device 20 executing a program corresponding to the game program 14. Additionally, part of the functional components may be provided in the terminal apparatus 12. For example, the facilitation means 52, the execution means 60, and the like may be provided in the terminal apparatus 12, instead of the server apparatus 10. Additionally, the storage means 50, the facilitation means 52, the payment processing means 54, the matching means 56, the display control means 58, the execution means 60, and the change means 62 in the present embodiment may be respectively read as a storage unit, a facilitation unit, a payment processing unit, a matching unit, a display control unit, an execution unit, and a change unit.

The storage means 50 has a function of storing, for example, play data 50A, musical performance venue data 50B, a musical performance schedule 50C, and musical performance data 50D. Note that part of data stored in the storage means 50 may be stored in the terminal apparatus 12. For example, the musical performance data 50D may be stored in the terminal apparatus 12.

The play data 50A is provided for each of the plurality of players. In the play data 50A, a progress status of the game, a player character available for a player in a main game, a status of the player character, a first virtual character that is operable in a musical performance venue or the like, an item, a currency (coin) in the game, a free crystal, a paid crystal, a cheer point, and the like are described. The paid crystal is a kind of an item that can be acquired by the player by taking a purchase procedure (a cash payment, an electronic payment, a credit-card transaction, or the like). Such a paid crystal may be referred to as, for example, a paid stone. Additionally, the free crystal is a kind of an item that can be acquired by the player by game play (execution of various kinds of games). For example, the free crystal can be acquired as a reward for log-in, clearing of a quest, completion of a mission, interaction with a friend, or the like. This free crystal may be referred to as, for example, a free stone. Additionally, the cheer point is a point indicating how much the player cheers for the musical performance. In a case where the player performs a predetermined action, the cheer point is given to the player as a parameter of a value according to the action (cheer point).

The musical performance venue data 50B is display data for displaying the musical performance venue in which a virtual performer character plays the musical performance, a waiting area, and the like. Note that the musical performance includes not only play of a musical instrument, but also an action of singing a song. In the present embodiment, the musical performance is a virtual live in which the performer's motion data and voice data recorded in real time is reflected in the virtual performer character in real time, whereby the virtual performer character looks as if he/she were dancing or singing. The reflection mentioned herein is to receive the motion data and the voice data using a technique of real-time motion capture or the like, and cause the virtual performer character to execute an action corresponding to the received data. Note that the motion data includes data of a change in facial expression, and a change in facial expression of the performer may be reflected in the virtual performer character in real time. The musical performance venue may be hereinafter referred to as a “live venue”.

In the musical performance schedule 50C, a time and date at which the musical performance is to be performed is described.

The musical performance data 50D includes data for outputting sound of the musical performance, data of the virtual performer character who performs the musical performance, and the like.

The facilitation means 52 includes a function of facilitating the game.

The payment processing means 54 has a function of making a predetermined item available to the player based on charging of money or payment for a game content made by the player.

The matching means 56 has a function of matching a plurality of players and any one of a plurality of live venues at which an identical musical performance is executed at the same time.

The display control means 58 has a function of performing display control of one live venue. For example, the display control means 58 performs display control of one live venue that is matched by the matching means 56 with respect to the terminal apparatuses 12 of two or more players.

Additionally, the display control means 58 has a function of performing display control of the virtual performer character, a first virtual character, a second virtual character, and these characters' actions executed by an execution means 60 in the live venue. The second virtual character mentioned herein is a character different from the first virtual character, and is a so-called non-player character (NPC) whose action is automatically controlled by a computer without a direct operation of the player. In the following description, the virtual performer character is referred to as a “performer character”, the first virtual character is referred to as a “player character”, and the second virtual character is referred to as a “non-player character”. An outer appearance and shape of the non-player character may be similar to those of the player character, or may be different from those of the player character.

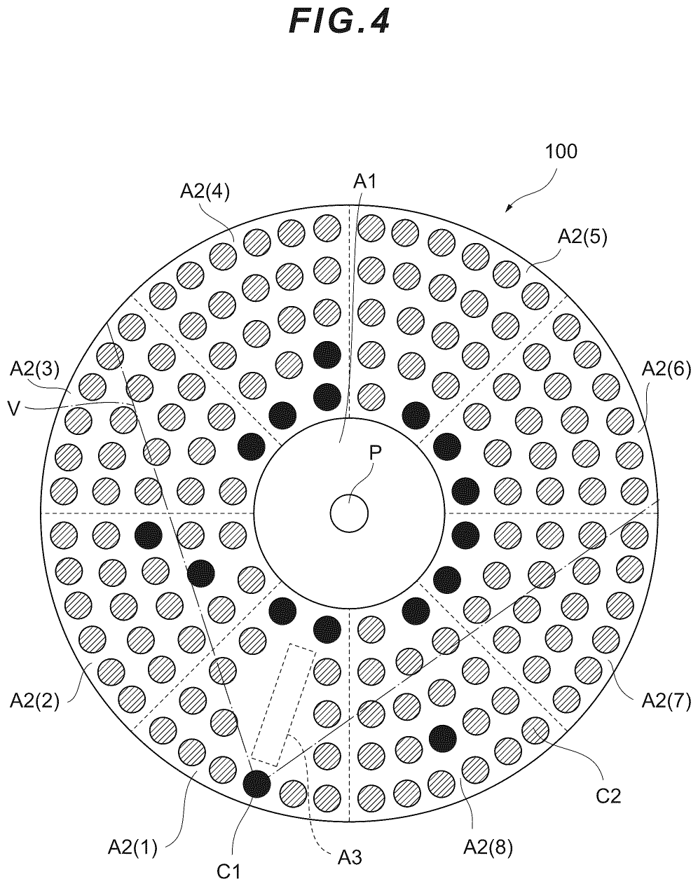

FIG. 4 is a view illustrating an example of an outline of the whole of a live venue 100.

As illustrated in FIG. 4, a stage area A1 and an audience seat area A2 are set in the live venue 100. The audience seat area A2 surrounds the stage area A1 by 360 degrees, and is configured to include areas A2(1) to A2(8). In FIG. 4, a performer character P is indicated by a white circle, a player character C1 is indicated by a black circle, and a non-player character C2 is indicated by a hatched circle.

The display control means 58 performs display control of one or more performer characters P in the stage area A1, and also performs display control of one or more player characters C1 and one or more non-player characters C2 in the audience seat area A2. The player character C1 and the non-player character C2 are movable within a range of the audience seat area A2. With the movement of the player character C1, a viewpoint moves from the audience seat area A2 toward the stage area A1. That is, the player can watch the stage area A1 from freely-selected 360-degree directions. The movement of the viewpoint of the player is performed by a gyro operation or the like.

In a case where a total capacity of the live venue 100 is about 1000 persons, the number of player characters C1 is about 100, and the number of non-player characters C2 is about remaining 900. It is preferable that the number of non-player characters C2 be more than the number of player characters C1. The plurality of player characters C1 corresponds to a self-player (one player) and a plurality of players other than the self-player (the other players). In the following description, out of the plurality of player characters C1, a player character C1 corresponding to the self-player is referred to as a “self-player character C1”, and player characters C1 corresponding the other players are referred to as “the other player characters (another player character) C1”. In FIG. 4, a visual field V of the self-player who operates the self-player character C1 is indicated by an alternate long and short dash line.

Additionally, in a case where the audience seat area A2 is divided into the plurality of areas A2(1) to A2(8), the display control means 58 performs display control of the non-player characters C2 so that a density of characters including the player characters C1 and the non-player characters C2 in each of the areas A2(1) to A2(8) is a predetermined value or more. In the following description, characters including the player characters C1 and the non-player characters C2 are referred to as “audience seat characters”. The display control means 58 displays an equivalent number of audience seat characters in each of the areas A2(1) to A2(8) so as not to cause an imbalance in density of audience seat characters in each of the areas A2(1) to A2(8). For example, there is a possibility that display positions of the player characters C1 are moved by the player's operation, but the display control means 58 disposes the non-player characters C2 and performs display control thereof so as not to cause an imbalance in density of audience seat characters in each of the areas A2(1) to A2(8).

For example, the display control means 58 uniformly disposes a sufficient number of non-player characters C2 that are close to the capacity of the live venue 100 in advance in the audience seat area A2 and performs display control. The display control means 58 disposes a predetermined number or more of non-player characters C2 without a space so as to approximately occupy each of the areas A2(1) to A2(8). In a case where a non-player character C2 is located within a predetermined range with respect to a player character C1 who has entered the live venue 100, the display control means 58 hides the non-player character C2. The predetermined range is set to have a such a distance as not to hinder an action of the player character C1, or such a distance as not to overlap the player character C1.

In a case where a non-player character C2 is located in a field of view area A3 of the self-player character C1, the predetermined range to be set is larger than that set in a case where a non-player character C2 is located in an area other than the field of view area A3 in the audience seat area A2. The field of view area A3 mentioned herein is an area between the self-player character C1 and the stage area A1, and an area along a direction from the self-player character C1 toward the stage area A1. In other words, the field of view area A3 mentioned herein is an area in which, if a non-player character C2 is present within the field of view area A3, the field of view of the self-player is blocked by the player character C1, and the stage area A1 is difficult to be seen. In this manner, by applying the predetermined range that is different depending on whether or not the position of the non-player character C2 is within the field of view area A3, the non-player character C2 within the field of view area A3 is more likely to be hidden than the non-player character C2 outside the field of view area A3. Note that all of the non-player characters C2 in the field of view area A3 may not be hidden.

Additionally, assuming that the above-mentioned predetermined range is a first predetermined range, in a case where the self-player character C1 is within a second predetermined range of another player character C1, the display control means 58 hides the other player character C1. The second predetermined range is set to be smaller than the first predetermined range. The first and second predetermined ranges are set in this manner, whereby the other player character C1 is less likely to be hidden than the non-player character C2 even if the other player character C1 approaches the self-player character C1 more closely.

Additionally, in a case where the virtual live should be brought to an emergency stop, the display control means 58 makes a transition of a screen of the player's terminal apparatus 12, and also executes emergency stop processing of displaying an error message on the player's terminal apparatus 12. Examples of the case where the virtual live should be brought to the emergency stop include a case where a failure indicating a state in which processing cannot be continued before or during execution of the virtual live or a trouble indicating some kind of a problem on the administrator's side occurs. Examples of the transition of the screen of the player's terminal apparatus 12 include switching of a screen on which display control of the live venue 100 is performed to a screen on which display control of the waiting area is performed, and switching of the screen on which the waiting area is displayed to a home screen. Note that in the case where the virtual live should be brought to the emergency stop, the display control means 58 may perform display control such as turning off of illumination of the live venue 100, turning off of musical performance sound, background music (BGM), or the like, and hiding of the performer character P.

Returning to FIG. 3, the execution means 60 has a function of causing each of the performer character P, the player characters C1, and the non-player characters C2 to execute a plurality of actions in the live venue 100. The execution means 60 causes the performer character P to execute an action according to an actual action such as a motion of the performer, a voice of the performer, or the like. Specifically, the execution means 60 receives the performer's motion data and voice data from the administrator's terminal apparatus 12 or the like, and causes the performer character P to execute an action of performing a motion according to the performer's motion data or perform an action of making a voice according to the performer's voice data. Examples of the motion according to the performer's motion data include a motion of keeping rhythm, a motion of moving his/her body, a motion of dancing, a motion of waving his/her hand(s), a motion of jumping, a motion of moving, a motion of changing an orientation, a motion of stopping, and a motion of posing. Examples of the voice according to the performer's voice data include a song, a conversation, and an utterance.

Additionally, the execution means 60 causes the player character C1 to execute a plurality of actions in response to an operation performed on the player's terminal apparatus 12, and causes the non-player character C2 to execute a plurality of actions under automatic control by a computer. The automatic control by the computer mentioned herein is automatic control by the computer regardless of the player's operation. Examples of the actions executed by the player character C1 or the non-player character C2 include an action of moving, an action of jumping, an action of keeping rhythm, an action of moving his/her body, an action of dancing, an action of waving his/her hand, an action of changing an orientation, an action of stopping, an action of posing, an action of posting a comment or a message, an action of presenting a virtual object to the live venue 100, an action of changing a display pattern of the virtual object, an action of putting (displaying) a stamp, an action of using an item, an action of throwing the item toward the stage area A1 or placing (displaying) the item on the stage area A1, and an action of outputting sound such as cheers and hand claps. The action of presenting the virtual object to the live venue 100 is to hand out and show the virtual object, raise the virtual object, wave the virtual object, move the virtual object, or the like in the live venue 100.

The virtual object is a virtual object associated with each of the characters C1 and C2. Examples of the virtual object include a personal item of each of characters C1 and C2 such as a penlight and a hand fan, a worn item of each of the characters C1 and C2 such as a costume including a T-shirt, and an element regarding a personal appearance of each of the characters C1 and C2 such as eyes and a hairstyle. In a case where the player character C1 executes the action of presenting the virtual object to the live venue 100, the virtual object associated with the player is presented to the live venue 100 in a display pattern selected in response to an operation performed on the player's terminal apparatus 12. In a case where the non-player character C2 executes the action, the virtual object associated with the non-player character C2 is presented to the live venue 100 in a display pattern selected under automatic control by the computer. Examples of the display pattern include a color, a shape, and a size. Specific examples of the action of presenting the virtual object to the live venue 100 in the selected display pattern include an action of handing out and showing, raising, waving, or moving a penlight or a hand fan in a selected color. Additionally, the action is not limited to such an action with the penlight, and may include an action of wearing (displaying) a costume in a selected color or a selected shape, an action of wearing (displaying) eyes or a hairstyle in a selected color or a selected shape, and the like. The following description will be given assuming that the virtual object is a “penlight” as one example and the display pattern is a “color” as one example. Additionally, the description will be given assuming that the action of presenting the virtual object to the live venue in the selected display pattern is a “penlight action” indicating an action of waving a penlight in a selected color.

Additionally, the execution means 60 has a function of causing the non-player character C2 to execute a different action depending on a status of the virtual live. For example, before the start of the musical performance, the execution means 60 causes the non-player character C2 to execute an action of moving within a predetermined movement range in the audience seat area A2. The predetermined movement range mentioned herein is, for example, a range within which the non-player character C2 moves several steps using an initial arrangement position before the movement of the non-player character C2 as a criterion. That is, the execution means 60 moves the non-player characters C2 within such a range as that a density of audience seat characters in the live venue 100 is not substantially changed even if the non-player character C2 is moved. When the musical performance is started, the execution means 60 then causes the non-player character C2 to execute an action of stopping the movement and changing the orientation toward the stage area A1 side. That is, the execution means 60 turns the face of the non-player character C2 toward the stage area A1 side. Note that, at this time, the execution means 60 may change the orientation of the non-player character C2 at a position where the non-player character C2 has been present at the starting time of the musical performance, or may return the non-player character C2 to the initial arrangement position and then change the orientation of the non-player character C2. Additionally, when the musical performance is started, the execution means 60 does not necessarily change the orientation of the non-player character C2 toward the stage area A1 side, and may cause the non-player character C2 to execute only the action of stopping the movement.

The change means 62 has a function of changing an action of the non-player character C2 depending on an action of the player character C1. The action of each of the characters C1 and C2 mentioned herein is not limited to an action subjected to display control of the display control means 58, and may be, for example, an action of outputting sound such as cheers and hand claps. However, in the present embodiment, a detailed description will be given of an example of the action subjected to display control by the display control means 58.

In the present embodiment, in a case where the player character C1 executes the penlight action, the change means 62 changes a color of a penlight of a non-player character C2 who is executing a penlight action according to a color of a penlight of the player character C1, the color being selected according to the player's operation. For example, the change means 62 changes the color of the penlight of the non-player character C2 so as to correspond to the penlight's color selected by the player such as by making the color identical to the penlight's color selected by the player. Additionally, in a case where a color of the penlight of the self-player character C1 and a color of the penlight of another player character C1 are different from each other, the change means 62 may change the color of the non-player character C2 by judging these colors in a comprehensive manner. For example, the change means 62 may change the color of the penlight of the non-player character C2 so as to be matched with the color of the penlight of the self-player character C1 on a priority basis over the color of the penlight of the other player character C1, or may change the color of the penlight of the non-player character C2 so as to be matched with a color whose number is the largest among colors of penlights of all the player characters C1 combining the self-player character C1 and the other player character C1.

In the present embodiment, the change means 62 also changes the color of the penlight associated with the non-player character C2 according to a total number or ratio of colors of penlights selected in response to the player's operation with respect to the plurality of player characters C1.

Specifically, the change means 62 aggregates, during a predetermined period, a total number or ratio of a color selected in response to each player's operation in the penlight action of each of the plurality of player characters C1. The change means 62 then changes the color of the penlight in the penlight action of each non-player character C2 according to a result of the aggregation. For example, the change means 62 changes the color of the penlight of each non-player character C2 so that the total number or ratio of the penlight's color selected in response to each player's operation in the live venue 100 is not largely changed by the color of the penlight of the non-player character C2.

### <Game Processing>

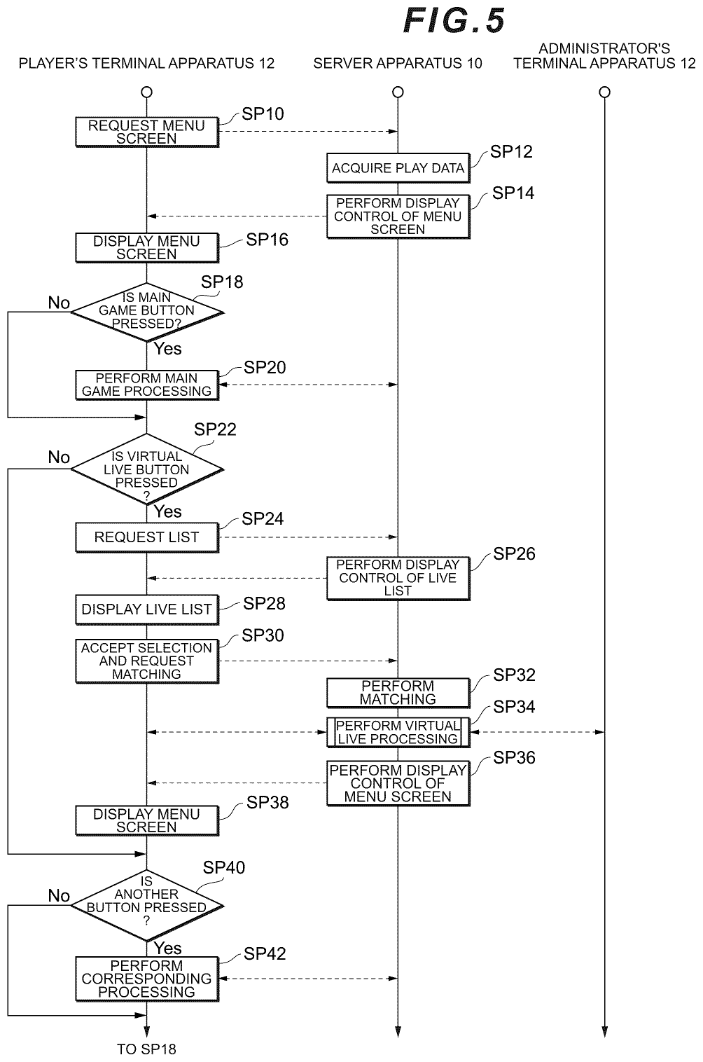

FIG. 5 is a flowchart describing an example of the flow of game processing in the game system 1 according to the present embodiment. The following processing is started, for example, in a case where the game program 14 is executed in the terminal apparatus 12. Note that the following order or contents of the processing can be changed as appropriate.

### (Step SP10)

The player's terminal apparatus 12 transmits a menu screen request for requesting a menu screen to the server apparatus 10. The menu screen request includes the player's player identification (ID). The processing then proceeds to processing in step SP12.

### (Step SP12)

The server apparatus 10 receives the menu screen request transmitted in the processing in step SP10. In response to the menu screen request, the server apparatus 10 acquires play data 50A corresponding to the player ID included in the menu screen request from the storage means 50. Subsequently, the facilitation means 52 of the server apparatus 10 reflects the acquired play data 50A in game data such as menu screen data and the like. The processing then proceeds to processing in step SP14. Note that in the processing in this step SP12, the server apparatus 10 may perform log-in authentication.

### (Step SP14)

The server apparatus 10 transmits the menu screen data in which the play data 50A is reflected in the processing in step SP12 to the terminal apparatus 12 as a request source, and thereby performs display control of the menu screen. The processing then proceeds to processing in step SP16.

### (Step SP16)

The player's terminal apparatus 12 receives the menu screen data transmitted in the processing in step SP14. In response to the reception, the terminal apparatus 12 displays the menu screen based on the received menu screen data. On the menu screen, for example, a main game button, a virtual live button, and one or more other buttons, which are not illustrated, are provided. The processing then proceeds to processing in step SP18.

### (Step SP18)

The player's terminal apparatus 12 determines whether or not the main game button has been pressed on the menu screen. In a case where the determination is made as YES, the processing proceeds to processing in step SP20. In a case where the determination is made as NO, the processing proceeds to processing in step SP22.

### (Step SP20)

The player's terminal apparatus 12 executes main game processing while communicating with the server apparatus 10. In the present embodiment, as the main game processing, rhythm game processing is executed. When the main game processing ends, the terminal apparatus 12 displays the menu screen. The processing then proceeds to processing in step SP22.

### (Step SP22)

The player's terminal apparatus 12 determines whether or not a virtual live button has been pressed on the menu screen. In a case where the determination is made as YES, the processing proceeds to processing in step SP24. In a case where the determination is made as NO, the processing proceeds to processing in step SP40.

### (Step SP24)

The player's terminal apparatus 12 transmits a list request for requesting a list of virtual lives to the server apparatus 10. The processing then proceeds to processing in step SP26.

### (Step SP26)

The server apparatus 10 receives the list request transmitted in the processing in step SP24. In response to the list request, the server apparatus 10 acquires a today's musical performance schedule 50C from the storage means 50. Subsequently, the server apparatus 10 generates live list data based on the acquired musical performance schedule 50C, transmits the live list data to the player's terminal apparatus 12, and thereby performs display control of a live list. The processing then proceeds to processing in step SP28.

### (Step SP28)

The player's terminal apparatus 12 receives the live list data transmitted in the processing in step SP26. In response to the reception, the terminal apparatus 12 displays a live list of one or more virtual lives to be held today based on the received live list data. The processing then proceeds to processing in step SP30. Note that on the live list, the time and date of the virtual live, a start time of the virtual live, an end time of the virtual live, and an acceptance start time of the virtual live may be displayed. Additionally, a selectable virtual live and an unselectable virtual live may be displayed in different display patterns. For example, a virtual live whose acceptance start time has not yet come and that is still unselectable may be grayed out.

### (Step SP30)

The player's terminal apparatus 12 accepts selection of one virtual live from the live list based on the player's operation. Sequentially, the terminal apparatus 12 transmits, to the server apparatus 10, a matching request including live ID of the selected virtual live and the player ID so that the player and any one of a plurality of live venues in which the selected virtual live is approximately simultaneously executed are matched with each other. Note that in a case of accepting the virtual live, the terminal apparatus 12 may determine whether or not the player has a ticket for the virtual live. In a case where the determination is made as YES, the player is decided as a paid player who can view the entirety of the virtual live. In a case where the determination is made as NO, the player is decided as a free player who can view part of the virtual live (within a free viewing range). The free viewing range may be, for example, preliminarily set as a predetermined range such as one-third of the entire time of the virtual live or designated by the administrator depending on a state of the virtual live or the like. The processing then proceeds to processing in step SP32.

### (Step SP32)

The server apparatus 10 receives the matching request transmitted in the processing in step SP30. In response to the matching request, the matching means 56 of the server apparatus 10 performs matching between the player ID included in the matching request and live venue ID that corresponds to live ID included in the matching request and that is live venue ID of any one of the plurality of live venues in which the identical live is simultaneously executed. Herein, each of the plurality of live venues can be matched with at least two or more players, such as ten players and twenty players. The processing then proceeds to processing in step SP34.

### (Step SP34)

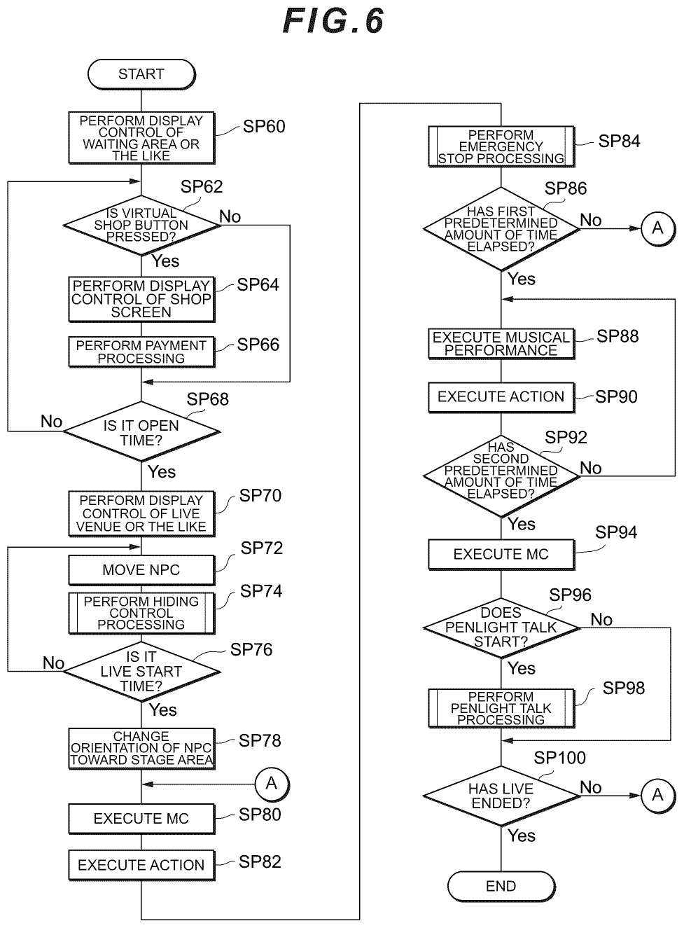

The server apparatus 10 executes virtual live processing for facilitating the virtual live while communicating with the player's terminal apparatus 12 or the administrator's terminal apparatus 12. Details of the virtual live processing will be described below with reference to FIG. 6. The processing then proceeds to processing in step SP36.

### (Step SP36)

The server apparatus 10 transmits the menu screen data to the terminal apparatus 12 as the request source, and thereby performs display control of the menu screen. The processing then proceeds to processing in step SP38.

### (Step SP38)

The player's terminal apparatus 12 receives the menu screen data transmitted in the processing in step SP36. In response to the reception, the terminal apparatus 12 displays the menu screen based on the received menu screen data. The processing then proceeds to processing in step SP40.

### (Step SP40)

The player's terminal apparatus 12 determines whether or not another button has been pressed on the menu screen. In a case where the determination is made as YES, the processing proceeds to processing in step SP42. In a case where the determination is made as NO, the processing returns to processing in step SP18.

### (Step SP42)

The player's terminal apparatus 12 executes corresponding processing corresponding to the other button while communicating with the server apparatus 10. Examples of the corresponding processing include list display processing of displaying a list of owned items, list display processing of displaying a list of owned characters, and game content lottery processing. Subsequently, when the corresponding processing ends, the terminal apparatus 12 displays the menu screen. The processing then returns to processing in step SP18.

### <Virtual Live Processing>

FIG. 6 is a flowchart describing an example of the flow of the virtual live processing described in step SP34 in FIG. 5. The following order or contents of the processing can be changed as appropriate. Additionally, in FIG. 6, the description of processing of the terminal apparatus 12 is omitted to avoid complications. Alternatively, the virtual live processing may be simultaneously executed in each of the plurality of live venues, or a different server apparatus 10 may perform the following processing on a live venue-by-live venue basis.

### (Step SP60)

The display control means 58 of the server apparatus 10 performs, on the terminal apparatuses 12 of two or more players, display control of a waiting area of a live venue matched with the player and a player character C1 corresponding to the player based on the play data 50A and the musical performance venue data 50B. Note that, since two or more players are matched with one live venue, respective player characters C1 corresponding to the two or more players are displayed in the one live venue or a corresponding waiting area. In the waiting area, it is possible to interact with players of the other player characters C1, purchase an item, a costume, or the like, set the self-player character C1's color, costume, accessory, penlight, action, or the like, and see a ranking regarding cheer points of each player. Note that the interaction with the players corresponding to the other player characters C1 can be performed by utilization of an action of putting a stamp or utilization of a chat. A location in which the interaction is performed is not limited to the waiting area, and the interaction may be performed within the live venue 100. In the present embodiment, a virtual shop button is provided in the waiting area to purchase the item, the costume, or the like. The processing then proceeds to processing in in step SP62.

### (Step SP62)

The display control means 58 determines whether or not the virtual shop button has been pressed in the waiting area. In a case where the determination is made as YES, the processing proceeds to processing in step SP64. In a case where the determination is made as NO, the processing proceeds to processing in step SP68.

### (Step SP64)

The display control means 58 performs display control a shop screen on the terminal apparatus 12 of the player who has pressed the virtual shop button. The processing then proceeds to processing in in step SP66.

### (Step SP66)

In a case where the costume, the accessory, or the like for the player character C1 is selected on the shop screen, the payment processing means 54 of the server apparatus 10 executes payment processing. Specifically, the payment processing means 54 executes payment in any one of three contents: coins, free crystals, and paid crystals in the player's play data 50A, and thereby adds the selected one to the player. Note that, in a case where the player purchases goods in the real world, the player character C1 may be able to receive and use an item corresponding to the goods in the main game or within the live venue 100. The processing then proceeds to processing in in step SP68.

### (Step SP68)

The display control means 58 determines whether or not it is an open time of the live venue 100 corresponding to the waiting area based on the musical performance schedule 50C. In a case where the determination is made as YES, the processing proceeds to processing in step SP70. In a case where the determination is made as NO, the processing returns to processing in step SP62.

### (Step SP70)

The display control means 58 performs, on each player's terminal apparatus 12, display control of an entrance of a corresponding live venue 100 in the waiting area. Subsequently, in a case where the entrance is selected by the player, the display control means 58 performs, on each player's terminal apparatus 12, display control of the live venue 100 corresponding to the waiting area, instead of the waiting area. Additionally, the display control means 58 performs display control of the player characters C1 and the non-player characters C2 on the player's terminal apparatus 12. Note that the description has been given of the case where the display control means 58 performs display control of the live venue 100 in a case where the entrance is selected by the player, but the display control means 58 may automatically perform display control of the live venue 100. Additionally, in a case where the player is determined as the free player in the processing in step SP30, the display control means 58 may perform display control of a live venue 100 for trial view, which is different from a live venue 100 for the paid player.

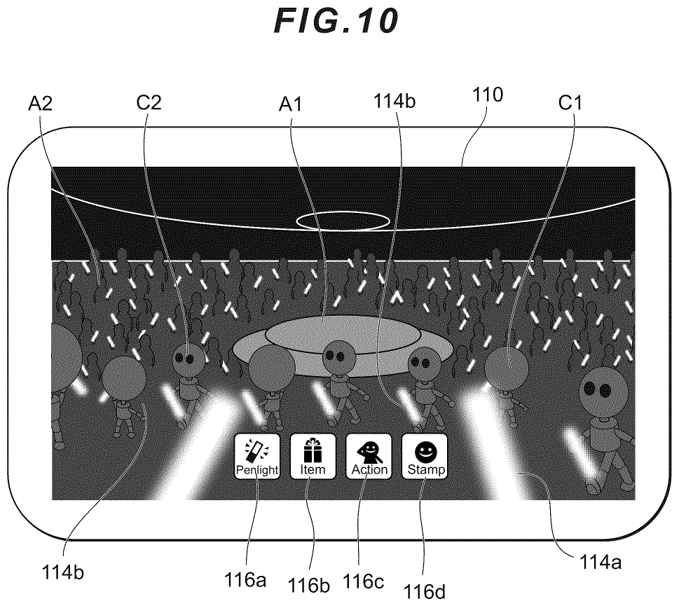

FIG. 10 is a view illustrating an example of a virtual live screen 110 that can be viewed from the visual field V of the player operating the self-player character C1 illustrated in FIG. 4.

As illustrated in FIG. 10, for example, the stage area A1 and the audience seat area A2 are displayed on the virtual live screen 110. Additionally, a penlight 114a of the self-player character C1 operated by the self-player is displayed on the near side of the virtual live screen 110. The following description will be given so that the penlight of the self-player character C1 is denoted by a reference sign 114a, and penlights of players other than the self-player character C1, that is, penlights of the other player characters and non-player characters are denoted by a reference sign 114b. Additionally, the virtual live screen 110 displays a state where a plurality of other player characters C1 and a plurality of non-player characters C2 are waiting for the start of the live in the audience seat area A2. Furthermore, before the start of the virtual live, an amount of illumination light emitted to the stage area A1 and the audience seat area A2 is set to be small similarly to before the start of a real live. Note that in FIG. 10, the player characters C1 and the non-player characters C2 have similar outer appearances, but may have different outer appearances.

Additionally, the virtual live screen 110 displays icons 116a, 116b, 116c, and 116d, which are execution buttons for causing the self-player character C1 to execute respective actions. The icon 116a is an execution button for executing the penlight action. The icon 116b is an execution button for executing an action such as an action of using an item, an action of throwing the item toward the stage area A1, and an action of placing the item on the stage area A1. The icon 116c is an execution button for executing a predetermined action such as an action of moving, an action of jumping, an action of keeping rhythm, an action of moving his/her body, an action of dancing, an action of changing an orientation, an action of stopping, an action of posing, and an action of outputting sound such as cheers and hand claps. The icon 116d is an execution button for executing an action of putting a stamp. The icons 116a to 116d are displayed or hidden at a predetermined timing.

Returning to FIG. 6, the processing proceeds to processing in step SP72.

### (Step SP72)

The execution means 60 of the server apparatus 10 moves a non-player character C2 within a predetermined movement range in the audience seat area A2. At this time, the non-player character C2 may move in a range of several steps from an initial position while holding the penlight 114b with his/her hand. Note that the penlight 114b may not be in a resting state, and may wave in a predetermined rhythm. The processing then proceeds to processing in step SP74.

### (Step SP74)

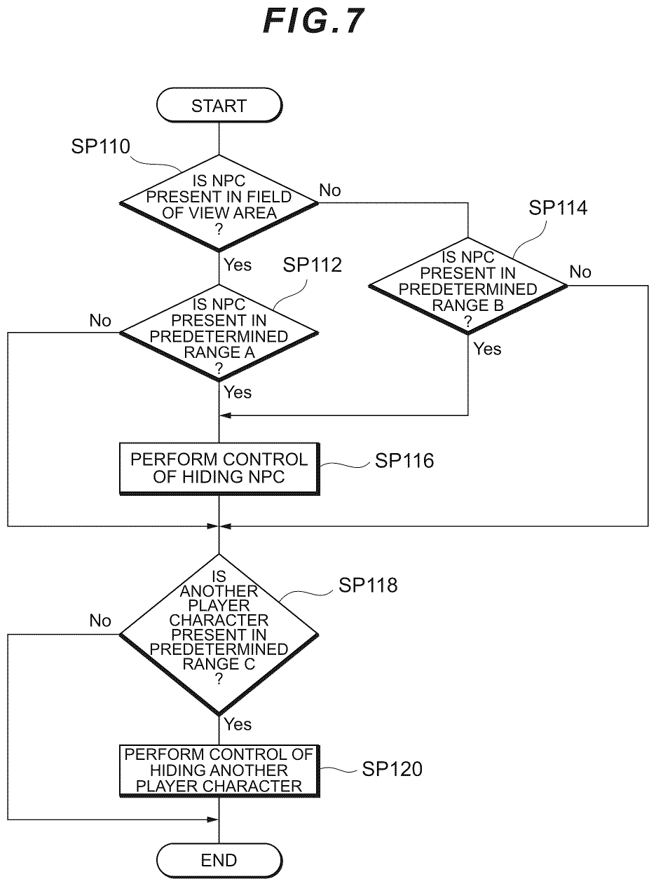

The display control means 58 executes hiding control processing. Details of the hiding control processing will be described below with reference to FIG. 7. Execution of the hiding control processing is not limited to before the start of the live, and may be during the live or after the live. In the hiding control processing, in a case where the non-player characters C2 are present within the field of view area A3, a non-player character C2 who is in a range distance from the self-player character C1 is hidden in comparison with a case where the non-player characters C2 are present in a range other than the field of view area A3 in the audience seat area A2.

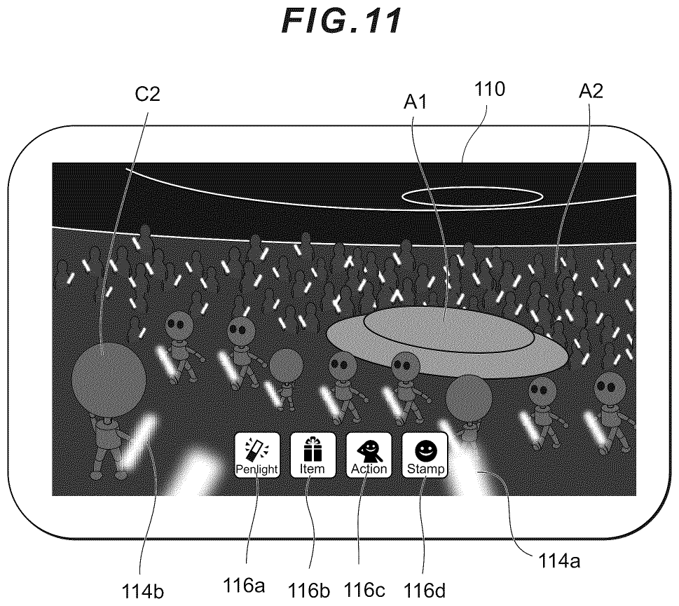

FIG. 11 is a view illustrating an example of the virtual live screen 110 that can be viewed in a case where the visual field V of the player operating the self-player character C1 illustrated in FIG. 4 is directed to the left side of the player.

As illustrated in FIG. 11, on the virtual live screen 110, a non-player character C2 located within the field of view area A3 of the self-player character C1 (refer to FIG. 4), that is, a non-player character C2 who is present between the self-player character C1 and the stage area A1 and near the self-player character C1 is hidden. In contrast, a non-player character C2 who is present outside the field of view area A3 and nearby the left side of the self-player character C1 is displayed.

Returning to FIG. 6, the processing proceeds to processing in step SP76.

### (Step SP76)

The facilitation means 52 of the server apparatus 10 determines whether or not it is a live start time of the virtual live based on the musical performance schedule 50C. In a case where the determination is made as YES, the processing proceeds to processing in step SP78. In a case where the determination is made as NO, the processing returns to processing in step SP72. Note that the execution means 60 may play predetermined background music (BGM) or a sound effect (SE) from the start of entrance to the live venue 100 to the start of the virtual live.

### (Step SP78)

The execution means 60 stops the movement of the non-player character C2, and changes the orientation of the non-player character C2 toward the stage area A1 side. Note that, at this time, the penlight 114b of the non-player character C2 may not be in the resting state, and may wave in a predetermined rhythm. The processing then proceeds to processing in step SP80.

### (Step SP80)

The display control means 58 performs display control of the performer character P on the player's terminal apparatus 12. The execution means 60 then receives the performer's motion data and voice data from the administrator's terminal apparatus 12 or the like in real time, reflects the motion data and the voice data in the performer character P, and thereby causes the performer character P to execute a master of ceremonies (MC). The MC mentioned herein is, a chat before and after the musical performance, facilitating, or the like. At this time, the execution means 60 may play the BGM, the SE, or the like that is preliminarily set for the MC based on the musical performance data 50D. Note that the MC execution processing may be omitted as appropriate. The processing then proceeds to processing in step SP82.

### (Step SP82)

In a case of receiving operation information transmitted from the terminal apparatus 12 of the player who is participating in the live venue 100, the execution means 60 causes the player character C1 to execute an action corresponding to the operation information. Note that, in a case of causing the player to execute, as the action, an action of using a predetermined item, the payment processing means 54 makes the item available to the player before the execution based on charging of money by the player or a payment in a game content (currency in the game, crystals, or the like). Note that, in a case where the item has been purchased in the waiting area, the payment such as the charging of money before the use of the item may be unnecessary.

After the action of the player character C1 is executed in the processing in step SP82, the performer may execute an actual action in response to the action, and the processing may return to the processing in step SP80. In this case, in the processing returned to step SP80, the execution means 60 receives data regarding the performer's action executed in response to the action of the player character C1 in real time from the administrator's terminal apparatus 12 or the like, and reflects the performer's action in the performer character P. Note that, for example, one or more live venues 100 selected from the live venues 100 subjected to display control performed on each of the terminal apparatuses 12 of the plurality of players are subjected to display control performed on the administrator's terminal apparatus 12, whereby the action of the player character C1 can be seen by the performer. In this manner, it is possible to experience the virtual live with interactivity between the performer and the player.

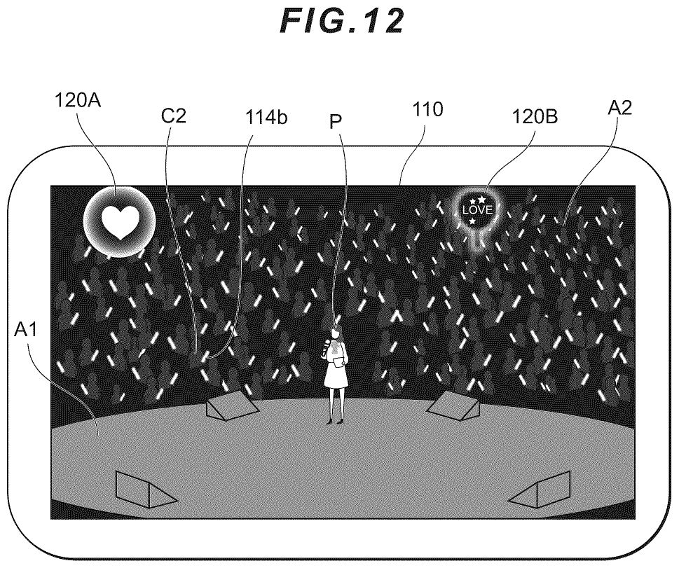

FIG. 12 is a view illustrating an example of the virtual live screen 110 that displays the MC being performed and that can be viewed in a case of zooming in on the stage area A1 side in the visual field V illustrated in FIG. 4.

As illustrated in FIG. 12, the performer character P is displayed in the stage area A1 on the virtual live screen 110 on which the MC is being executed. At this time, illumination (brightness and darkness) of the live venue 100 may be controlled in real time in step with the state of the MC or the like. Additionally, an effect such as spotlight may be controlled so as to follow the moving performer character P. Furthermore, the virtual live screen 110 displays a plurality of non-player characters C2 in the audience seat area A2 on the background side of the performer character P.

Additionally, the virtual live screen 110 displays stamps 120A and 120B used by the player's operation. The stamp 120A represents a heart stamp, and the stamp 120B represents a hand fan stamp. Additionally, in a case where a predetermined item, such as a flower bouquet and a letter, is used by the player, the virtual live screen 110 may display the item in the stage area A1. Furthermore, the virtual live screen 110 may display a comment, a message, or the like to the performer character P, which has been input by the player's operation. Note that although not illustrated in FIG. 12, in a case where the self-player character C1 is executing the penlight action, the virtual live screen 110 may display the penlight 114a on the near side of the screen similarly to FIG. 10.

Returning to FIG. 6, the processing proceeds to processing in step SP84.

### (Step SP84)

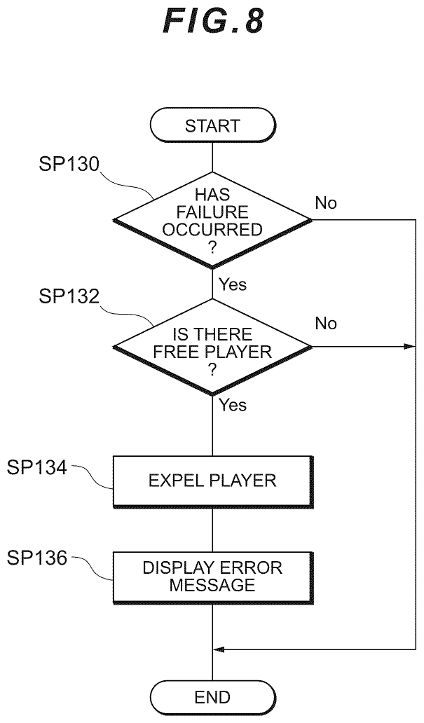

The display control means 58 executes emergency stop processing. Details of the emergency stop processing will be described below with reference to FIG. 8. A timing of the emergency stop processing is not limited to during the execution of the MC, but may be a predetermined timing in the virtual live processing.

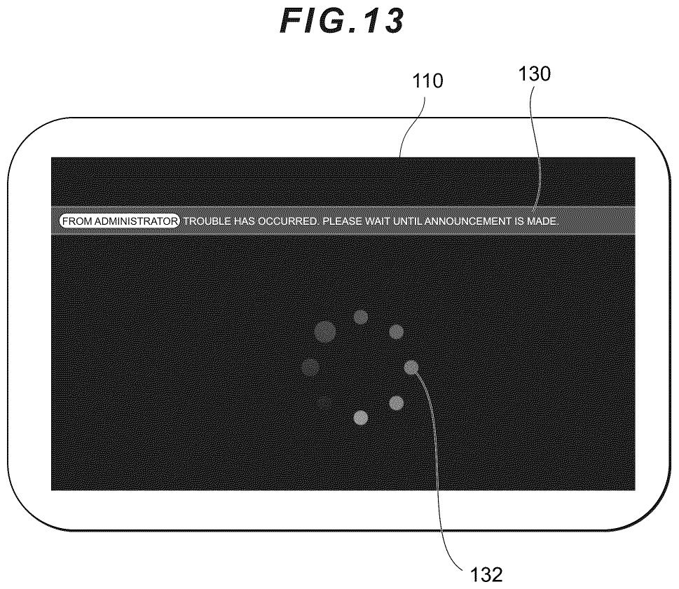

FIG. 13 is a view illustrating an example of the virtual live screen 110 at the time of an emergency stop.

As illustrated in FIG. 13, the virtual live screen 110 at the time of the emergency stop displays an error message 130 and a mark 132 indicating that connection is being established.

Returning to FIG. 6, the processing proceeds to processing in step SP86.

### (Step SP86)

The facilitation means 52 determines whether or not a first predetermined amount of time has elapsed. In a case where the determination is made as YES, the processing proceeds to processing in step SP88. In a case where the determination is made as NO, the processing returns to processing in step SP80. The first predetermined amount of time is a predetermined amount of time (timing) as an MC execution time before the musical performance, and there is one or a plurality of first predetermined amounts of time. Alternatively, the facilitation means 52 may determine, instead of the determination about whether or not the first predetermined amount of time has elapsed, whether or not the administrator has performed a predetermined operation on the terminal apparatus 12 to switch the execution of the MC to the execution of the musical performance.

### (Step SP88)

Based on the musical performance data 50D, the execution means 60 plays musical performance sound that is preliminarily set in association with the performer, a schedule of the virtual live, or the like, and also executes a stage direction of the live venue 100 in conjunction with the musical performance sound. For example, the execution means 60 may execute the stage direction set for each musical performance sound such as musical performance sound A, musical performance sound B, and musical performance sound C, and may change the stage direction for each musical performance sound. Alternatively, the execution means 60 may change, during one musical performance sound, the stage direction for each timing, each sound volume, each tempo, or the like of the musical performance sound. Examples of the stage direction for the live venue 100 in conjunction with the musical performance sound include various stage directions such as illumination emitted toward the stage area A1 and the audience seat area A2, cheers and hand claps that are made in the live venue 100, decoration of the stage area A1, movement of the stage area A1, and the appearance of a vehicle such as a gondola on which the performer character P can ride. Additionally, the execution means 60 receives the performer's motion data and voice data in real time from the administrator's terminal apparatus 12 or the like, reflects the motion data and the voice data in the performer character P, and thereby causes the performer character P to dance and sing to the musical performance sound. The processing proceeds to processing in step SP90.

### (Step SP90)

The execution means 60 causes the player character C1 to execute the action similarly to the processing in step SP82. At this time, for example, when the player performs, on the terminal apparatus 12, the operation for executing the action according to the musical performance sound played in the processing in step SP98, dancing of the performer character P, or a beat of a song, the execution means 60 causes the player character C1 to execute an action according to the beat. Examples of the action include an action of waving the penlight 114b, an action of keeping rhythm, an action of moving a body, an action of dancing, and an action of moving. For example, by the player's operation, the player characters C1 are caused to wave the penlights 114a and 114b or execute the operation of waving the penlights 114a and 114b widely or vigorously at a timing according to the musical performance sound, the dancing of the performer character P, or the beat of the song.

Additionally, the execution means 60 causes the non-player character C2 to change the action in conjunction with the musical performance sound played in the processing in step SP89. For example, the execution means 60 changes the action of the non-player character C2 at a preset timing according to the beat of the musical performance sound, that is, a sound volume and a tempo. Examples of the action include an action of waving the penlight 114b, an action of keeping rhythm, an action of moving a body, an action of dancing, and an action of moving. For example, the execution means 60 makes these actions larger and more vigorous in a part of the musical performance sound in which a sound volume becomes larger or a part of the musical performance sound in which a tempo becomes faster. Additionally, the execution means 60 may change the action of the non-player character C2 in conjunction with the stage direction executed in the processing in step SP89 in the live venue 100 regardless of the musical performance sound. For example, the execution means 60 may make these actions larger and more vigorous at a preset timing according to cheers and hand claps generating in the live venue 100 in a part in which cheers and hand claps become larger or a part in which a tempo becomes faster. The processing proceeds to processing in step SP92.

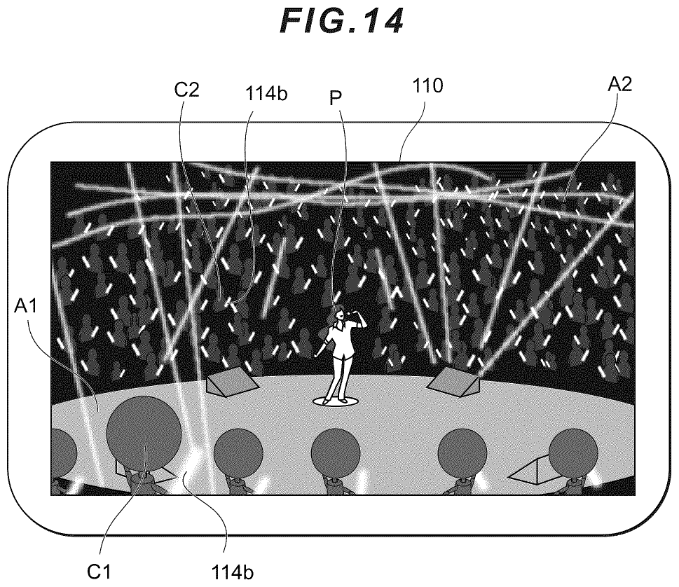

FIG. 14 is a view illustrating an example of the virtual live screen 110 that has been switched from a screen displaying the execution of the MC illustrated in FIG. 12 and that displays the execution of the musical performance.

As illustrated in FIG. 14, the virtual live screen 110 displays a state where a plurality of other player characters C1 on the near side of the stage area A1 when viewed from the self-player character C1 and a plurality of non-player characters C2 on the rear side of the stage area A1 when viewed from the self-player character C1 are waving the penlights 114b according to the musical performance sound, the dancing of the performer character P, or the beat of the song. Note that the non-player characters C2 may be present on the near side of the stage area A1 and the other player characters C1 may be present on the rear side of the stage area A1. Furthermore, similarly to the virtual live screen 110 displaying the execution of the MC illustrated in FIG. 12, this virtual live screen 110 may also display the stamps 120A and 120B, the item used by the player's operation, or the comment, the message, or the like to the performer character P input by the player's operation.

Additionally, although not illustrated, a tap button for instructing a timing for executing a predetermined action may be displayed at a predetermined timing associated with the musical performance sound. In a case where the tap button is operated by the player, a predetermined action may be executed. Note that although not illustrated, a tap button for generating hand claps and cheers around the player may be displayed at a predetermined timing associated with the musical performance sound. In a case where the tap button is operated by the player, hand claps and cheers may be generated around the player. Note that although not illustrated in FIG. 14, in a case where the self-player character C1 executes the penlight action, this virtual live screen 110 may also display the penlight 114a on the near side of the screen similarly to that in FIG. 10. Note that when the player's viewpoint moves, display control of the stage area A1 and the performer character P so as to change in orientation corresponding to the viewpoint is performed on the virtual live screen 110. At this time, display control may be performed on the virtual live screen 110 so that to change an effect such as the orientation, position, brightness of the spotlight in real time according to the player's viewpoint. Additionally, it may be possible for the player to capture a screenshot of the virtual live screen 110 corresponding to a predetermined viewpoint and store the screenshot in the player's terminal apparatus 12.

Returning to FIG. 6, the processing proceeds to processing in step SP92.

### (Step SP92)

The facilitation means 52 determines whether or not a second predetermined amount of time has elapsed. In a case where the determination is made as YES, the processing proceeds to processing in step SP94. In a case where the determination is made as NO, the processing returns to processing in step SP80. The second predetermined amount of time is a predetermined amount of time (timing) as an amount of time from the start of the musical performance until the start of the MC after the musical performance, and there is one or a plurality of second predetermined amounts of time. Additionally, the facilitation means 52 may determine, instead of the determination about whether or not the second predetermined amount of time has elapsed, whether or not the administrator has performed a predetermined operation on the terminal apparatus 12 to switch the execution of the musical performance to the execution of the MC.

### (Step SP94)

The execution means 60 receives the performer's motion data and voice data from the administrator's terminal apparatus 12 or the like in real time, reflects the motion data and the voice data in the performer character P, and thereby causes the performer character P to execute the MC. At this time, the execution means 60 may play the BGM, the SE, or the like that is preliminarily set for the MC based on the musical performance data 50D. Note that the MC execution processing may be omitted as appropriate. The processing then proceeds to processing in step SP96.

### (Step SP96)

The facilitation means 52 determines whether or not to start a penlight talk. For example, in a case where the administrator inputs, to the terminal apparatus 12, an operation to start the penlight talk and the facilitation means 52 receives this operation information from the terminal apparatus 12, the facilitation means 52 makes determination as YES. Then, in a case where the determination is made as YES, the processing proceeds to processing in step SP98. In a case where the determination is made as NO, the processing proceeds to processing in step SP100. The penlight talk mentioned herein is a stage direction to determine the performer's response such as what the performer is going to talk during the execution of the MC out of a plurality of conversation topics (talk topics) based on a total number or ratio of penlights' colors selected by the plurality of players who is participating in the live venue 100.

### (Step SP98)

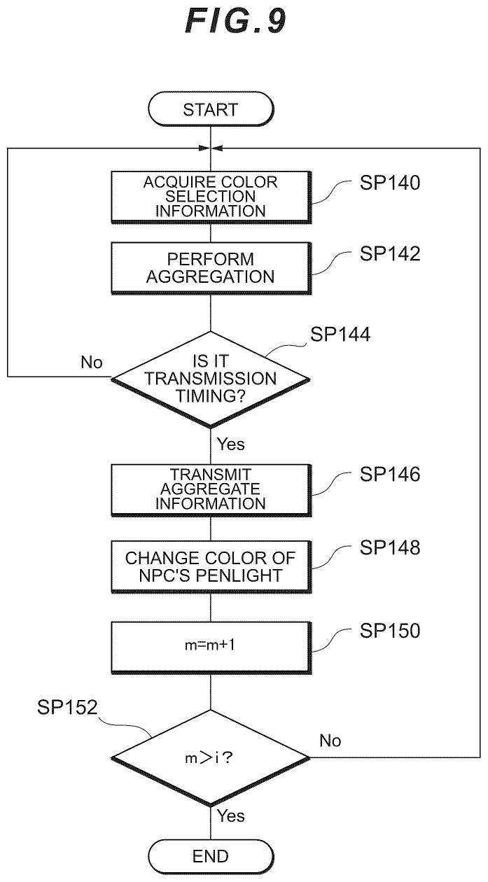

The change means 62 of the server apparatus 10 executes penlight talk processing. Details of the penlight talk processing will be described later with reference to FIG. 9. A timing of the execution of the penlight talk processing is not limited to during the execution of the MC after the end of the musical performance, but may be during the execution of the MC before the start of the musical performance or the like. The processing then proceeds to processing in step SP100.

### (Step SP100)

The facilitation means 52 determines whether or not the virtual live has ended. Then, in a case where the determination is made as YES, a series of processing described in FIG. 6 ends. In a case where the determination is made as NO, the processing returns to processing in step SP80.

### <Hiding Control Processing>

FIG. 7 is a flowchart describing an example of the flow of hiding control processing described in step SP74 in FIG. 6. Note that the following order or contents of the processing can be changed as appropriate.

### (Step SP110)

The display control means 58 determines whether or not the non-player character C2 is present in the field of view area A3 (refer to FIG. 4). In a case where the determination is made as YES, the processing proceeds to processing in step SP112. In a case where the determination is made as NO, the processing proceeds to processing in step SP114.

### (Step SP112)

The display control means 58 determines whether or not the non-player character C2 in the field of view area A3 is present within a predetermined range A with respect to the self-player character C1. In a case where the determination is made as YES, the processing proceeds to processing in step SP116. In a case where the determination is made as NO, the processing proceeds to processing in step SP118.

### (Step SP114)

The display control means 58 determines whether or not the non-player character C2 in an area outside the field of view area A3 in the audience seat area A2 is present within a predetermined range B with respect to the self-player character C1. The predetermined range B is set to be smaller than the predetermined range A. In a case where the determination is made as YES, the processing proceeds to processing in step SP116. In a case where the determination is made as NO, the processing proceeds to processing in step SP118.

### (Step SP116)

The display control means 58 hides the non-player character C2 with respect to which the determination has been made as YES in processing in step SP112 or step SP114. The processing then proceeds to processing in step SP118.

### (Step SP118)

The display control means 58 determines whether or not another player character C1 is present within a predetermined range C with respect to the self-player character C1. The predetermined range C is set to be larger than at least the predetermined range B. In a case where the determination is made as YES, the processing proceeds to processing in step SP120. In a case where the determination is made as NO, a series of processing described in FIG. 7 ends.

### (Step SP120)

The display control means 58 hides the other player character C1 with respect to which the determination has been made as YES in the processing in step SP118. Then, the series of processing described in FIG. 7 ends.

### <Emergency Stop Processing>

FIG. 8 is a flowchart describing one example of the flow of emergency stop processing described in step SP84 in FIG. 6. Note that the following order or contents of the processing can be changed as appropriate.

### (Step SP130)

The facilitation means 52 determines whether or not a failure or a trouble has occurred. In a case where the determination is made as YES, the processing proceeds to processing in step SP132. In a case where the determination is made as NO, a series of processing described in FIG. 8 ends.

### (Step SP132)

The facilitation means 52 determines whether or not there is a free player among players participating in the live venue 100. In a case where the determination is made as YES, the processing proceeds to processing in step SP134. In a case where the determination is made as NO, the series of processing described in FIG. 8 ends.

### (Step SP134)

The display control means 58 performs such display control as to forcibly expel the free player, with respect to which the determination is made as YES in the processing in step SP132, from the live venue 100 to a designated location. The designated location is, for example, the waiting area. That is, the display control means 58 makes a transition of a screen on which display control of the live venue 100 is performed to a screen on which display control of the waiting area is performed. The processing then proceeds to processing in step SP136.

### (Step SP136)

The display control means 58 performs display control of an error message to inform the player of what has occurred. The error message may be, for example, preliminarily set, or may be input from the administrator's terminal apparatus 12 on a management side, or the like.

Note that the description has been given with reference to the flowchart in FIG. 8, assuming that only the free player is forcibly expelled, but the processing is not limited thereto. For example, in a case where the determination processing in step SP130 is made as YES, a selected player or all the players may be forcibly expelled regardless of whether these players are paid players or free players. Additionally, the above description has been given of the example of expelling the player in the live venue 100 to the waiting area, but a destination of expelling may be different depending on a location in which the player is present. For example, in a case where the player is in the waiting area, the display control means 58 may make a transition from the screen on which display control of the waiting area is performed to the home screen or the like. Additionally, not only in the case of the emergency stop, but also in a case where, for example, a condition for ending a free viewing range is satisfied, processing of expelling the free player as described in step SP134 may be performed. Examples of the condition for ending the free viewing range include the elapse of a predetermined amount of time preliminarily set in the administrator's terminal apparatus 12 and an instruction for ending (cancelling) the free viewing range being made from the administrator's terminal apparatus 12. That is, the processing of expelling the free player may be performed in a case where the predetermined amount of time preliminarily set has elapsed or the instruction for ending (cancelling) the free viewing range has been made as the condition for ending the free viewing range.

### <Penlight Talk Processing>

FIG. 9 is a flowchart describing an example of the flow of the penlight talk processing described in step SP98 in FIG. 6. Note that the following order or contents of the processing can be changed as appropriate.

### (Step SP140)

The change means 62 acquires color selection information indicating the penlights' colors selected by the plurality of players through operations of the terminal apparatuses 12 by transmission from the respective terminal apparatuses 12. The processing then proceeds to processing in step SP142.

### (Step SP142)

The change means 62 aggregates the color selection information acquired in the processing in step SP140. Note that a method of aggregation may be manually or automatically performed. The processing then proceeds to processing in step SP144.

### (Step SP144)

The change means 62 determines whether or not it is a timing to transmit aggregate information aggregated in the processing in step SP142 to the player's terminal apparatus 12. The timing may be set at, for example, a timing of five seconds from the start of aggregation. Then, in a case where the determination is made as YES, the processing then proceeds to processing in step SP146. In a case where the determination is made as NO, the processing returns to processing in step SP140.

### (Step SP146)

The change means 62 transmits the aggregate information aggregated in the processing in step SP142 to the player's terminal apparatus 12. Additionally, the aggregate information is transmitted also to the administrator's terminal apparatus 12, and it is possible for the performer who is executing the MC to determine a talk topic depending on a ratio of colors indicated by the transmitted aggregate information. Note that the performer may visually see colors of penlights in the live venue 100 and determine the ratio of the colors and determine the talk topic without transmission of the aggregate information to the administrator's terminal apparatus 12. That is, the performer changes the talk topic adopted in the MC depending on the aggregate information of the colors of the penlights. The processing then proceeds to processing in step SP148.

### (Step SP148)

The change means 62 then changes the colors of the penlights of the non-player characters C2 according to the aggregate information transmitted to the player's terminal apparatus 12 in the processing in step SP146. In a case where a ratio of blue to red as the colors of the penlights is 2 to 3 as the aggregate information, the change means 62 changes the colors of the penlights of the non-player characters C2 so that a ratio of blue to red as the colors of the penlights in the whole live venue 100 including the penlights of the player characters C1 and the penlights of the non-player character C2 is maintained to be this ratio of 2 to 3. The change means 62 changes the colors of the penlights of the non-player characters C2 at every predetermined transmission timing in the processing in step SP144, and can thereby gradually change the colors without changing the colors at once. Additionally, the change means 62 may change the musical performance sound output in the virtual live, stage directions during the virtual live including an illumination effect and staging according to the aggregate information transmitted to the player's terminal apparatus 12 in the processing in step SP146. The processing then proceeds to processing in step SP150.

### (Step SP150)

The change means 62 increments a number m of transmissions of the aggregate information to the player's terminal apparatus 12 (an initial value is 1). The processing then proceeds to processing in step SP152.

### (Step SP152)

The change means 62 determines whether or not the number m of transmissions exceeds a preset number (for example, 6). In a case where the determination is made as YES, a series of processing in FIG. 9 ends, and the processing proceeds to processing in step SP146. In a case where the determination is made as NO, the processing returns to processing in step SP140. Note that, after the end of the penlight talk processing, the change means 62 holds the colors of the penlights of the non-player characters C2 for a predetermined period of time and then returns to control in a normal mode.

### <Actions and Effects>

As described above, in the present embodiment, a program causes the server apparatus 10 as a computer that is communicable with the terminal apparatus 12 of the player who participates in the live venue 100 in which the predetermined musical performance or the predetermined performance is executed to function as: the execution means 60 that causes the performer character P to execute an action according to the performer's motion or voice, causes each player character C1 to execute an action according to an operation in the player's terminal apparatus 12, and causes each non-player character C2 to execute an action under automatic control by the computer; and the change means 62 that changes the action of each non-player character C2 according to the action of the player character C1.

According to this configuration, it is possible to change the action of each non-player character C2 according to the action of the player character C1. Thus, for example, even in a case where the player character C1 executes an unpredicted action that is distinctive of a live musical performance, each non-player character C2 can perform a behavior corresponding to the player's action, and it is possible to approximate the virtual live venue 100 to a real live venue. As a result, it is possible to give the player a sense of immersion, which is a sense as if the player were participating in a live in a real live venue.

Additionally, in the present embodiment, the server apparatus 10 as the computer further functions as the display control means 58 that performs, on the player's terminal apparatus 12, display control of the live venue 100 and also display control of the performer character P, the player characters C1, the non-player characters C2, and the characters P, C1, and C2's actions executed by the execution means 60. The execution means 60 causes each player character C1 to execute an action of presenting, to the live venue 100, a penlight as a virtual object associated with the player character C1 in a color selected according to an operation in the player's terminal apparatus 12, and causes each non-player character C2 to execute an action of presenting, to the live venue 100, a penlight as a virtual object associated with the non-player character C2 in a color as a form selected by automatic control by the computer. The change means 62 changes the penlight's color associated with each non-player character C2 according to the color selected according to the operation with respect to the player character C1.

According to this configuration, it is possible to change the color of the penlight presented by each non-player character C2 so as to correspond to the color of the penlight presented by the player character C1. As a result, it is possible to suppress each non-player character C2 from performing a behavior not corresponding to the player character C1 who is performing a behavior according to a beat in the live venue 100, and prevent spoiling of the player's sense of immersion into the virtual live.

Additionally, in the present embodiment, the display control means 58 performs display control of a plurality of player characters C1 corresponding to a plurality of players. The execution means 60 executes an action of presenting, to the live venue 100, penlights as respective virtual objects associated with the plurality of player characters C1 in colors selected according to operations in respective players' terminal apparatuses 12. The change means 62 changes colors of penlights as virtual objects associated with the non-player characters C2 according to a total number or ratio of colors selected according to operations with respect to the plurality of player characters C1.

According to this configuration, it is possible to make a ratio of colors of all penlights in the live venue 100 including the penlights of the player characters C1 and the penlights of the non-player characters C2 identical to a ratio of colors of the penlights of the player characters C1. This can prevent, in a case where the performer executes the stage direction of the penlight talk, the ratio of colors of all the penlights shown as an outer appearance from deviating from the ratio of colors of penlights selected by the player to determine the performer's response, and can thereby prevent the player from having a sense of incongruity. Additionally, for example, in a case where a total number of a color of the penlights of the player characters C1 is a predetermined value or more and large or in other cases, it is also possible to, for example, match the color of the penlights of the non-player characters C2 with this color, and prevent the penlights of the non-player characters C2 from being the odd one out.

Additionally, in the present embodiment, in a case where the non-player characters C2 is located within a predetermined range with respect to each player character C1, the display control means 58 hides the non-player character C2.

According to this configuration, hiding the non-player character C2 near the player character C1 can prevent the player's sense of immersion into the virtual live from being spoiled, which is caused by the non-player character C2 near the player character C1 drawing the player's attention or becoming an obstacle.

Additionally, in the present embodiment, the display control means 58 performs display control of the performer character P in the stage area A1 of the live venue 100 and also performs display control of the characters C1 and C2 in the audience seat area A2 of the live venue 100. In a case where the non-player characters C2 are located in the field of view area A3, which is an area between the self-player character C1 and the stage area A1 and along the direction from the self-player character C1 to the stage area A1, the predetermined range to be set is larger than that in a case where the non-player characters C2 are located in an area other than the field of view area A3 in the audience seat area A2.

According to this configuration, the non-player characters C2 located in the field of view area A3 are more likely to be hidden than the non-player characters C2 located at a position other than the field of view area A3. That is, the non-player characters C2 located at such positions as to block the player's field of view in a direction from the self-player character C1 to the stage area, including those located far from the player character C1, are hidden in comparison with the non-player characters C2 that are not located in the field of view area A3 and that do not block the field of view. This can actively remove such non-player characters C2 as to block the player's field of view from the player's field of view, and appropriately prevent spoiling of the player's sense of immersion into the virtual live. Additionally, since the non-player characters C2 not blocking the field of view are displayed, for example, even if they are located right next to the player character C1, the player can have a sense of being surrounded by the other audience, and experience a realistic sense closer to that in a real live.

Additionally, in the present embodiment, assuming that the above-mentioned predetermined range is a first predetermined range, the display control means 58 performs display control of a plurality of player characters C1 corresponding to a plurality of players including one player and players other than the one player. In a case where another player characters C1 out of the plurality of player characters C1 is located within a second predetermined range that is smaller than the first predetermined range, the display control means 58 hides the other player character C1.

According to this configuration, the other player character C1 is not hidden even if being located closer to the self-player character C1 than the non-player character C2 to the self-player character C1. As a result, the other player character C1 is hidden so as not to become an obstacle to the self-player character C1, but is harder to be hidden than the non-player character, whereby opportunities for communication through which players interact with each other can be left as much as possible.

Additionally, in the present embodiment, before the start of the musical performance or the performance, the execution means 60 causes each non-player character C2 to execute an action of moving within a predetermined movement range in the audience seat area A2 of the live venue 100. After the start of the musical performance or the performance, the execution means 60 causes each non-player character C2 to execute an action of stopping the movement and changing in orientation to the stage area A1 side of the live venue 100.

This configuration allows each non-player character C2 to execute an action according to a status before and after the start of the virtual live, and can thereby provide the player with an experience closer to that in a real live.

Additionally, in the present embodiment, in a case where the audience seat area A2 in the live venue 100 is divided into the plurality of areas A2(1) to A2(8), the display control means 58 performs display control of a plurality of non-player characters C2 so that a density of audience seat characters including the player characters C1 and the non-player characters C2 in each of the areas A2(1) to A2(8) is a predetermined value or more.

This configuration enables display of the audience seat characters in the audience seat area A2 in a dense and unbiased manner, and allows audience seats to appear to be filled with a large audience in an unbiased manner like a real popular live venue.

### <Modifications>

The present invention is not limited to the above-described embodiment. That is, what is obtained by addition of a design change to the above-mentioned embodiment by the person skilled in the art is included in the scope of the present invention as long as including the features of the present invention. Additionally, elements included in the above-mentioned embodiment and modifications, which will be described later, may be combined as long as it is technically possible, and what is obtained by combination of these elements is included in the scope of the present invention as long as having the features of the present invention.

For example, the display control means 58 of the server apparatus 10 may display a management screen that manages comments, messages, and the like posted together with money from players to the performer on the administrator's terminal apparatus 12.

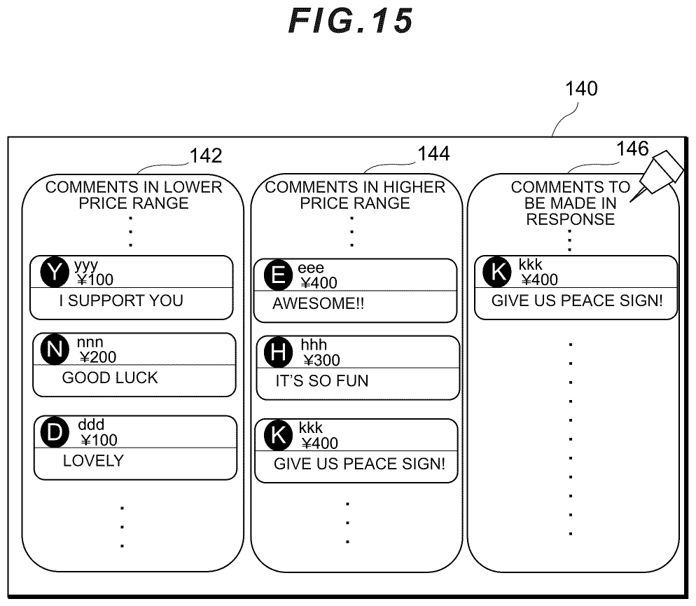

FIG. 15 is a view illustrating an example of a comment management screen 140 displayed on the administrator's terminal apparatus 12.

As illustrated in FIG. 15, a display field 142 for comments in a lower price range, a display field 144 for comments in a higher price range, and a display field 144 for comments to be made in response are displayed on the comment management screen 140. The display control means 58 classifies comments from the players into the lower price range and the higher price range, and performs display control by dividing the comments into the display fields 142 and 144. Comments from the players flow in and are displayed on the display fields 142 and 144 in real time. Additionally, the display control means 58 pins and displays, on the display field 146 in a fixed manner, a comment selected by the administrator or the like as a comment to be made in response by the performer. This configuration can facilitate, for example, the administrator's extraction work to extract comments in a ratio of comments in the lower price range and comments in the higher price range as 2 to 3 or the like. In addition to the above, since the comment to be made in response is individually displayed in a fixed manner and can be thereby highlighted in an easily understood manner, the performer reads the comment to be made in response and can thereby easily make a response to a comment.

Note that the screen for managing the players' comments is not limited to the screen illustrated in FIG. 15. Examples of other screens include a screen for displaying a list of names of players who have made comments during the virtual live and causing the performer to read the names of the players. Additionally, in a case where there is an inappropriate comment among comments collected in real time, the display control means 58 may perform processing of expelling the player who has made the inappropriate comment from the live venue 100, processing of stopping a game account of the player, or the like.

Additionally, the display control means 58 may perform display control of a management screen 160 that manages an error message at the time of an emergency stop on the administrator's terminal apparatus 12.

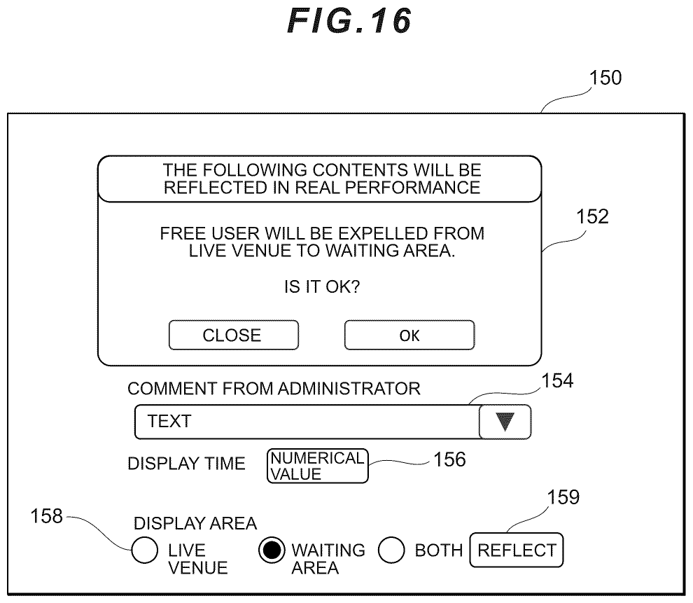

FIG. 16 is a view illustrating an example of a management screen 150 that is displayed on the administrator's terminal apparatus 12 at the time of the emergency stop.

As illustrated in FIG. 16, the management screen 150 at the time of the emergency stop displays a preview 152 of the error message, a comment entry field 154, a display time entry field 156, a check box 158, and a reflect button 159. The administrator inputs or selects a predetermined text in/from the comment entry field 154 at the time of the emergency stop, inputs or selects a predetermined value in/from the display time entry field 156, and checks an area in which an error message is to be displayed in the check box 158. Then, when the administrator presses the reflect button 159, the error message is displayed in an area checked in the designated check box 158. With this configuration, it is possible to appropriately change the error message, the display time, or the like subjected to display control performed on the player's terminal apparatus 12 at the time of the emergency stop.

Additionally, in the above-mentioned embodiment, the description has been given of the example in which the change means 62 changes the action of each non-player character C2 according to the action of the player character C1, but the configuration is not limited thereto, and the change means 62 may change the action of each non-player character C2 according to, for example, the action of the performer character P. Additionally, in a case where the action of the performer character P or the action of the player character C1 changes, the change means 62 may change the action of each non-player character C2 according to the action after the change.

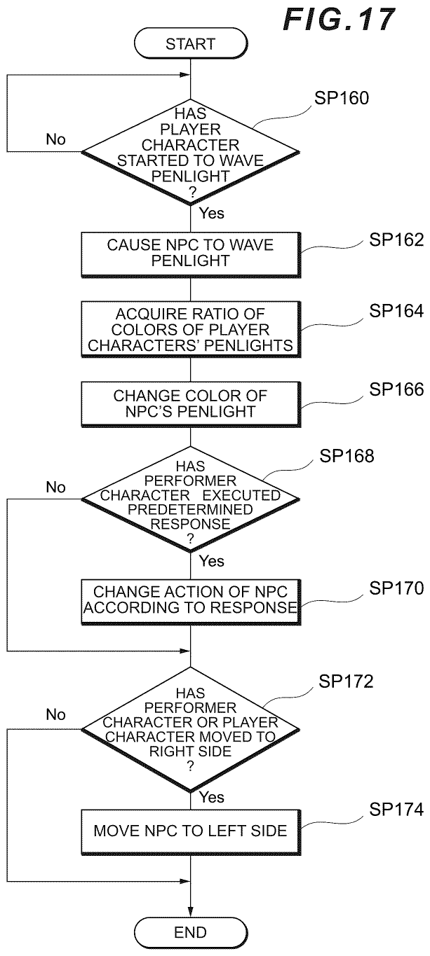

FIG. 17 is a flowchart describing the flow of processing of the change means 62 according to a modification. Note that the following order or contents of the processing can be changed as appropriate.

### (Step SP160)

The change means 62 determines whether or not the player character C1 has started to wave the penlight. That is, the change means 62 determines whether or not the action of the player character C1 has changed from an action other than an action of waving the penlight including a stop state or the like to the action of waving the penlight. The player character C1 mentioned herein may be the self-player character C1 or another player character C1. Additionally, the change means 62 may determine whether or not a predetermined number or more of player characters C1 out of the plurality of player characters C1 have started to wave penlights. In a case where the determination is made as YES, the processing then proceeds to processing in step S162. In a case where the determination is made as NO, the processing in step SP160 is repeated until the determination is made as YES.

### (Step SP162)

The change means 62 causes each non-player character C2 to execute the action of waving the penlight. That is, the change means 62 changes the action of each non-player character C2 from the action other than the action of waving the penlight including the stop state or the like to the action of waving the penlight. The change means 62 extracts non-player characters C2 who are executing the action other than the action of waving the penlights out of the plurality of non-player characters C2, and causes the non-player characters C2 to execute the action of waving the penlights. At this time, the change means 62 may also cause the non-player characters C2 whose number is identical to the number of player characters C1 who have started to wave the penlights in step SP160 to wave the penlights, and may match the colors of the penlights of the player characters C1 and the colors of the penlights of the non-player characters C2 with each other. The processing then proceeds to processing in step SP164.

### (Step SP164)

The change means 62 acquires color selection information regarding the player characters C1 who participate in the live venue 100, aggregates the color selection information, and thereby acquires a ratio of the colors of the penlights of the player characters C1 in the live venue 100. The processing then proceeds to processing in step SP166.

### (Step SP166)

The change means 62 changes the colors of the penlights of the non-player characters C2 according to the ratio of the colors acquired in the processing in step SP164. For example, the change means 62 changes the colors of the penlights of the non-player characters C2 so that a ratio of colors of penlights in the whole live venue 100 including the penlights of the player characters C1 and the penlights of the non-player characters C2 becomes similar to the ratio of the colors acquired in the processing in step SP164. Additionally, the change means 62 may change the colors of the penlights of the non-player characters C2 so that a total number of each of a plurality of colors of penlights in the live venue 100 becomes approximately identical. The processing then proceeds to processing in step SP168.

### (Step SP168)

The change means 62 determines whether or not the performer character P has executed a predetermined response. Examples of the predetermined response include a response to ask the audience for some kind of a response, such as a response to ask for cheers toward the audience, a response to perform a predetermined motion to give a boost to the audience such as raising of the arm and shaking of the head, and a response to pose toward the audience. In a case where the determination is made as YES, the processing proceeds to processing in step S170. In a case where the determination is made as NO, the processing proceeds to processing in step SP172.

### (Step SP170)

The change means 62 changes the action of each non-player character C2 according to the performer character P's response with respect to which the determination is made as YES in the processing in step SP168. For example, the change means 62 changes the action of each non-player character C2 to the action of sending cheers with hand claps, the penlight, or the like according to the performer character P's response to ask for cheers. Additionally, the change means 62 changes the action of each non-player character C2 to an action according to the motion of the performer character P or another action, according to the performer character P's response to make a predetermined motion to give a boost to the audience. Additionally, the change means 62 changes the action of each non-player character C2 to an action of performing a motion like taking a picture or another action according to the performer character P's response to pose toward the audience. The processing then proceeds to processing in step SP172.

### (Step SP172)

The change means 62 determines whether or not the performer character P or the player character C1 has moved from a present position to a position at a predetermined distance in a predetermined direction (for example, the right side). In a case where the determination is made as YES, the processing proceeds to processing in step S174. In a case where the determination is made as NO, a series of processing described in FIG. 17 ends.

### (Step SP174)

The change means 62 moves each non-player character C2 in a direction (for example, the left side) opposite to the direction of the movement made in the processing in step SP172. Then, the series of processing described in FIG. 17 ends.

As described above, according to the modification, for example, it is possible for each non-player character C2 to start waving the penlight in conjunction with the start of the player character C1 to wave the penlight. Additionally, it is possible to change the action of each non-player character C2 as appropriate according to the change of the action of the performer character P or the action of the player character C1 such as a movement. Thus, it is possible for each non-player character C2 to change the action according to a beat or the like that can only be predicted in a real live, and it is possible to provide a sense that is closer to a sense in the real live in comparison with a case where the action is executed at a computer-controlled, predetermined timing.

Additionally, in the above-mentioned embodiment, the description has been given of the example of changing the action of the non-player characters C2 according to the player characters C1 corresponding to respective players including the self-player and the other players, but the action of the non-player characters C2 may be changed according to the actions of the other player characters C1 corresponding only to the other players excluding the self-player.

Additionally, changing the action of the non-player characters C2 according to the action of the performer character P or the action of the player character C1 is not necessarily limited to changing the action of the non-player characters C2 to an action identical to the action of the performer character P or the action of the player character C1 or to an action having a similar meaning, and for example, may be changing the action of the non-player characters to an action having an opposite meaning, or the like. For example, in a case where the player character C1 executes such an action as to bring the performer's feeling down, the action of the non-player characters C2 may be changed to an action of uplifting the performer's feeling as a complement in an opposite manner. Additionally, the change means 62 may change, not only the action subjected to display control by the display control means 58, but also, for example, an action of outputting sound such as cheers and hand claps. That is, the change means 62 may change the action of the non-player characters C2 from a predetermined action to an action of outputting sound such as cheers and hand claps according to the action of the performer character P or the action of the player character C1.

Additionally, in the above-mentioned embodiment, the description has been given of the example of uniformly arranging a sufficient number of non-player characters C2 in the audience seat area A2 and performing display control, but the configuration is not limited thereto, and the non-player characters C2 may be arranged at a predetermined position other than a position at which the player character C1 is predicted to be located and be subjected to display control. In this case, for example, even if a density of the audience seat characters in the audience seat area A2 is a predetermined value or more at the start of the virtual live, there is a possibility that the density is changed due to the movement of the player character C1 in the audience seat area A2, the entrance and exit of the player character C1 from the live venue 100, or the like and becomes the predetermined value or less, and a non-dense area (gap) is generated in the live venue 100. In such a case, the non-player characters C2 may be arranged afterwards to fill the non-dense area, and display control may be performed. As a result, it is possible to deal with a case where the non-dense area that cannot be filled only with non-player characters that have been initially arranged at the start of the virtual live is generated afterwards due to the influence of the live musical performance or the like.

Additionally, the matching between two or more players out of the plurality of players and any one of the plurality of live venues 100 is not necessarily performed. The plurality of players may not participate in the live venue 100, and one player may be only required to participate.

The action of the performer character P is not necessarily executed by reflection of the motion data and the voice data in real time, and may be executed, for example, by reflection of the motion data and the voice data preliminarily recorded in part or the whole of the action. Additionally, the game system 1 may provide, to the player, not only a live stream of the virtual live in real time, but also an archived stream that allows the player to view the virtual live during the musical performance or after the musical performance whenever the player wants to view. The archived stream can be viewed including the actions of the player characters C1 and the non-player characters C2, and the performer character P's responses to the actions.

Various kinds of screens subjected to display control on the terminal apparatus 12 are not limited to those described in the above-mentioned embodiment. Examples of the other screens include a screen for confirming the entrance and exit to/from the live venue 100 with the player, a screen for setting the number of the other players C1 and the number of the non-character players C2 subjected to display control in the live venue 100, and a screen for making a setting for anti-camera shake when the player moves in the virtual live.

Additionally, as a stage direction for approximating the virtual live to the real live venue and a stage direction for giving a boost to the virtual live, various stage directions other than the above-mentioned stage directions may be performed. For example, a stage direction for showing the status of the performer character P in the stage area A1, the status of the player characters C1 and the non-player characters C2 in the audience seat area A2 on a wall monitor installed in the live venue 100 may be performed. Additionally, display control of advertisements of sponsors may be performed in the waiting area and the live venue 100. Additionally, for example, a predetermined content that is delivered within the game, such as an item that has been used by the other player character C1 or the performer character P in the live venue 100 and that does not belong to the self-player and a rare item may be sold.

Additionally, the server apparatus 10 may have a functional component other than the above-mentioned functional components. For example, the server apparatus 10 may include a giving means for giving cheer points to the player who has made an action according to the action. Specifically, the giving means adds cheer points according to the action to cheer points recorded in the play data 50A of the player who has made the action. For example, the giving means adds “1” cheer point in a case where the executed action is the action of waving the penlight, and “3” cheer points in a case where the executed action is the action of posting a comment or a message. Additionally, the giving means adds “2” cheer points in a case where the executed action is the action of jumping, and “4” cheer points in a case where the executed action is the action of using an item. Additionally, the giving means may change the cheer points to be added depending on an item. For example, in a case of an item that requires payment for use such as charging of money, cheering points to be added may be made higher. In a case of an item that does not require payment such as charging of money, cheering points to be added may be made lower. Note that each added value of the above-mentioned cheer points is merely an example, and is not specifically limited. Additionally, in a case where the cheer points reach a threshold, the giving means may not add the cheer points excluding an action of using the item. The cheer points may be used for purchase of an item, a costume, or the like used in the main game or the virtual live, participation in a virtual live to be held in a limited manner, cultivation of a character, or the like. Additionally, for example, an action that can be used by the player may be variable depending on the cheer points, and the execution means 60 may be capable of causing the player character C1 to execute a rare action that is only used by a player having many cheer points depending on an operation of the player having many cheer points. Additionally, the cheer points may be exchangeable with the other players.

Furthermore, in the above-mentioned embodiment, the description has been given of the memory 24 and the storage device 28 as the recording medium, but the recording medium is not limited to the memory 24 and the storage device 28. The recording medium may be, for example, a storage device such as a hard disk drive (HDD) built into the computer system and a solid state drive (SSD), or a movable medium such as a magnetic optical disk, a read-only memory (ROM), a compact disc (CD)-ROM, and a flash memory.

### REFERENCE SIGNS LIST

10: Server apparatus (computer, information processing apparatus)
12: Terminal apparatus
58: Display control means
60: Execution means
62: Change means

1. A computer-readable recording medium recording a program for causing a computer that is communicable with a terminal apparatus of a player who participates in a venue in which a predetermined musical performance or a predetermined performance is executed to function as:
an execution unit configured to cause a virtual performer character corresponding to a performer who performs the predetermined musical performance or the predetermined performance to execute an action according to a motion or voice of the performer, cause a first virtual character corresponding to the player to execute an action according to an operation on the player's terminal apparatus, and cause a second virtual character who is different from the first virtual character to execute an action under automatic control by the computer; and
a change unit configured to change the action of the second virtual character according to the action of the virtual performer character or the action of the first virtual character.

2. The recording medium according to claim 1, wherein the program causes the computer to further function as
a display control unit configured to perform, on the player's terminal apparatus, display control of the venue and also display control of the virtual performer character, the first virtual character, the second virtual character, and an action of each character to be executed by the execution unit, wherein
the execution unit is configured to cause the first virtual character to execute an action of presenting, to the venue, a virtual object associated with the first virtual character in a display pattern selected according to an operation on the player's terminal apparatus, and cause the second virtual character to execute an action of presenting, to the venue, a virtual object associated with the second virtual character in the display pattern selected by automatic control by the computer, and
the change unit is configured to change a display pattern of the virtual object associated with the second virtual character according to the display pattern selected according to the operation regarding the first virtual character.

3. The recording medium according to claim 2, wherein
the display control unit is configured to perform display control of a plurality of the first virtual characters corresponding to a plurality of the players,
the execution unit is configured to cause the plurality of first virtual characters to execute an action of presenting, to the venue, corresponding virtual objects associated with the plurality of first virtual characters in corresponding display patterns selected according to operations on respective players' terminal apparatuses, and
the change unit is configured to change the display pattern of the virtual object associated with the second virtual character according to a total number or ratio of the display patterns selected regarding the plurality of first virtual characters according to the operations.

4. The recording medium according to claim 2, wherein the display control unit is configured to hide the second virtual character in a case where the second virtual character is located within a predetermined range with respect to the first virtual character.

5. The recording medium according to claim 4, wherein
the display control unit is configured to perform display control of the virtual performer character in a stage area of the venue and also display control of the first and second virtual characters in an audience seat area of the venue, and
in a case where the second virtual character is located in an area between the first virtual character corresponding to one player and the stage area and along a direction from the first virtual character toward the stage area, the predetermined range to be set is larger than a predetermined range to be set in a case where the second virtual character is located in an area other than the area in the audience seat area.

6. The recording medium according to claim 4, wherein
when the predetermined range is a first predetermined range, the display control unit is configured to perform display control of a plurality of the first virtual characters corresponding to a plurality of the players including one player and another player other than the one player, and in a case where a first virtual character corresponding to the other player out of the plurality of first virtual characters is located, with respect to a first virtual character corresponding to the one player out of the plurality of first virtual characters, in a second predetermined range that is smaller than the first predetermined range, also configured to hide the first virtual character corresponding to the other player.

7. The recording medium according to claim 2, wherein the execution unit is configured to, before start of the musical performance or the performance, cause the second virtual character to execute an action of moving within a predetermined movement range in an audience seat area of the venue, and also configured to, after the start of the musical performance or the performance, cause the second virtual character to execute an action of stopping the movement and changing in orientation to a stage area side of the venue.

8. The recording medium according to claim 2, wherein the display control unit is configured to perform display control of a plurality of the second virtual characters so that a density of characters including the first virtual character and the second virtual characters in each of the areas is a predetermined value or more in a case where an audience seat area of the venue is divided into a plurality of areas.

9. The recording medium according to claim 1, wherein when the action of the virtual performer character or the action of the first virtual character changes, the change unit is configured to change the action of the second virtual character according to the changed action.

10. An information processing apparatus that is communicable with a terminal apparatus of a player who participates in a venue in which a predetermined musical performance or a predetermined performance is executed, the information processing apparatus comprising:
an execution unit configured to cause a virtual performer character corresponding to a performer who performs the predetermined musical performance or the predetermined performance to execute an action according to a motion or voice of the performer, cause a first virtual character corresponding to the player to execute an action according to an operation on the player's terminal apparatus, and cause a second virtual character who is different from the first virtual character to execute an action under automatic control by a computer; and
a change unit configured to change the action of the second virtual character according to the action of the virtual performer character or the action of the first virtual character.
